(19) United States
(12) Patent Application Publication
(10) Pub. No.: US 2012/0315972 A1
(43) Pub. Date: Dec. 13, 2012

(54) GAMING ACCESSORY AND INTERFACE APPARATUS FOR MULTIFUNCTIONAL GAMING PLATFORM

(75) Inventors: Craig Alan Olson, Vaughn, WA (US); Robert Arthur Bangerter, III, Redmond, WA (US); John David Silverman, Seattle, WA (US); Brian James Compton, Kenmore, WA (US); Marisa Lynn Pena, Seattle, WA (US); David Allen Beecher, Redmond, WA (US)

(73) Assignee: DISCOVERY BAY GAMES, INC., Seattle, WA (US)

(21) Appl. No.: 13/158,441

(22) Filed: Jun. 12, 2011

(51) Int. Cl. A63F 9/24; G06F 19/00

(52) U.S. Cl. 463/17; 463/40

(57) ABSTRACT

An interface apparatus for multifunctional gaming platform is provided. The interface apparatus couples a host device featuring a display and a gaming accessory. The host device is configured to generate at least one set of host-data. At least one set of host-data is selected from the group consisting of: a change of color of a display of the host-device; a variation of intensity of color of the display of the host-device; a sequence of flashing patterns generated by the display of the host-device; and a change of a background theme of the display of the host-device. The host data is used to enable the operation of the gaming accessory.

### TECHNICAL FIELD

The technology relates to the field of gaming, and more specifically, is directed to a multifunctional gaming platform.

### BACKGROUND

A new revolutionary device iPAD launched in the Spring of 2010 includes a plurality of built-in apps designed from the ground up to take advantage of the large Multi-Touch screen and advanced capabilities of iPAD.

The present technology utilizes iPAD capabilities (as well as capabilities of other similar devices like a smartphone, a tablet computer, a portable media player, a netbook; a smartbook, an e-Reader, etc.) to make iPAD (and similar devices like a smartphone, a tablet computer, a portable media player, a netbook, a smartbook; an e-Reader, etc.) a part of a multifunctional gaming platform.

### SUMMARY

This Summary is provided to introduce a selection of concepts that are further described below in the Detailed Description. This Summary is not intended to identify key or essential features of the claimed subject matter, nor is it intended to be used as an aid in determining the scope of the claimed subject matter.

An interface apparatus for multifunctional gaming platform is provided. The interface apparatus couples a host device featuring a display and a gaming accessory. The host device is configured to generate at least one set of host-data.

At least one set of host-data is selected from the group consisting of: a change of color of a display of the host-device; a variation of intensity of color of the display of the host-device; a sequence of flashing patterns generated by the display of the host-device; and a change of a background theme of the display of the host-device.

The interface apparatus further comprises a detector capable of detecting at least one set of host-data, a processor configured to process at least one set of host-data to recover at least one host-control signal, and a means for activating the gaming accessory by using at least one recovered host-control signal.

### DESCRIPTION OF THE DRAWINGS

The accompanying drawings, which are incorporated in and form a part of this specification, illustrate embodiments of the technology and, together with the description, serve to explain the principles below:

FIG. 1 illustrates a system block diagram of the multifunctional gaming platform including the host device, the Duo gaming accessory, and the light interface apparatus for the purposes of the present technology.

FIG. 2 shows a host device block diagram for the purposes of the present technology.

FIG. 3 depicts a block diagram of the Duo gaming accessory and the light interface apparatus for the purposes of the present technology.

FIG. 4 illustrates a rotating disk of the Duo gaming accessory for the purposes of the present technology.

FIG. 5 shows a hardware block diagram of the Duo gaming accessory and the light interface apparatus for the purposes of the present technology.

FIG. 6 illustrates system operation of the Duo gaming accessory and the light interface apparatus for the purposes of the present technology.

### DETAILED DESCRIPTION

Reference now is made in detail to the embodiments of the technology, examples of which are illustrated in the accompanying drawings. While the present technology will be described in conjunction with the various embodiments, it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific-details are set forth in order to provide a thorough understanding of the presented embodiments. However, it will be obvious to one of ordinary skill in the art that the presented embodiments may be practiced without these specific details. In other instances, well known methods, procedures, components, and circuits have not been described in detail as not to unnecessarily obscure aspects of the presented embodiments.

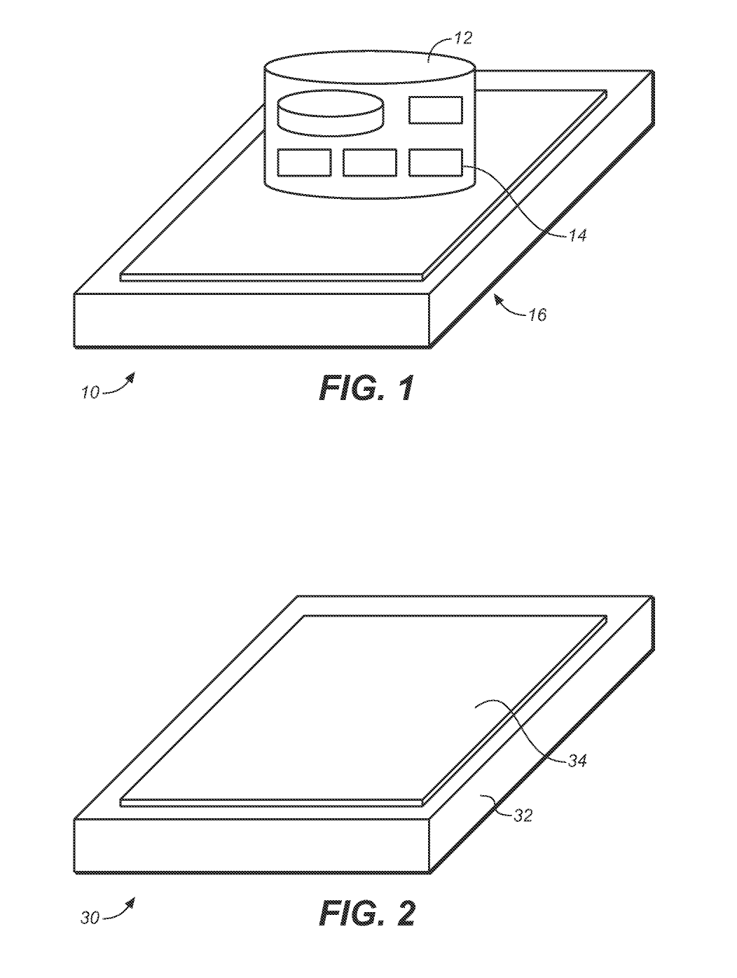

In an embodiment of the present technology, FIG. 1 illustrates a system block diagram 10 of the multifunctional gaming platform including the host device 16, the Duo gaming accessory 12, and the light interface apparatus 14.

In an embodiment of the present technology, the host device 16 is selected from the group consisting of: a wired electronic device; and a wireless electronic device.

In an embodiment of the present technology, the wireless host device 16 is selected from the group consisting of: a smartphone: a tablet computer; a portable media player; a netbook; a smartbook; and an e-Reader.

In an embodiment of the present technology, a smartphone is selected from the group consisting: an iPhone; an iPhone 3G; an iPhone 3GS; iPhone 4; and a Google Android phone.

In an embodiment of the present technology, a tablet computer is selected from the group consisting of: A Sakshat; an iPAD; an Android based Google tablet; a Microsoft Tablet PC; a Microsoft Ultra-Mobile PC (UMPC); and a Nokia 770 Internet Tablet.

In an embodiment of the present technology, a portable media player is selected from the group consisting: an iPod Touch; and an MP4 player.

In an embodiment of the present technology, the netbook is selected from the group consisting of: a Dell netbook; an ASUS Eee PC; a Linux-based CloudBook; a Lenovo S10e netbook; and a Lenovo Mini 10 netbook.

In an embodiment of the present technology, the smartbook is selected from the group consisting of: a Qualcomm smartbook; and a Smartbook AG portable computer.

In an embodiment of the present technology, the e-Reader is selected from the group consisting of: A Nintendo e-Reader; an E-book; an Amazon Kindle; a Sony reader; and a Barnes & Noble nook.

A. iPhone; iPhone 3G; iPhone 3GS; iPhone 4

Referring still to FIG. 1, in an embodiment of the present technology, the wireless host device 16 comprises an iPhone. The iPhone is a line of Internet and multimedia-enabled smartphones designed and marketed by Apple Inc. The first iPhone was introduced on Jan. 9, 2007. An iPhone functions as a camera phone, including text messaging and visual voicemail, a portable media player, and an Internet client, with e-mail, web browsing, and Wi-Fi connectivity. The user interface is built around the device's multi-touch screen, including a virtual keyboard rather than a physical one. Third-party applications are available from the App Store, which launched in mid-2008 and now has well over 200,000 “apps” approved by Apple. These apps have diverse functionalities, including games, reference, GPS navigation, social networking, and advertising for television shows, films, and celebrities.

There have been four generations of iPhone hardware, and they have been accompanied by four major releases of iOS (formerly iPhone OS). The original iPhone established design precedents like screen size and button placement that have persisted through all models. The iPhone 3G brought 3G cellular network capabilities and A-GPS location. The iPhone 3GS brought a compass, faster processor, and higher resolution camera, including video. The iPhone 4 has two cameras for FaceTime video calling and a higher resolution display. It was released on Jun. 24, 2010 in certain countries and is in the process of being released worldwide.

### Screen and Input

The touch screen is a 9 cm (3.5 in) liquid crystal display with scratch-resistant glass. The capacitive touch screen is designed for a bare finger, or multiple fingers for multi-touch sensing. The screens on the first three generations of the iPhone have a resolution of 320×480 (HVGA) at 163 ppi, while the display on the iPhone 4 has a resolution of 640×960 at 326 ppi. The touch and gesture features of the iPhone are based on technology originally developed by FingerWorks. Most gloves and styluses prevent the necessary electrical conductivity. The iPhone 3GS also features a fingerprint-resistant oleophobic coating. The top and side of the iPhone 3GS, externally identical to the iPhone 3G. The switches were black plastic on the original model. From left to right, sides: wake/sleep button, SIM card slot, headphone jack, silence switch, volume controls. Top: earpiece, screen. Thus, the iPhone has a minimal hardware user interface, featuring only four or five buttons, depending on whether the volume control is counted as one button or two.

The only physical menu button is situated directly below the display, and is called the “Home button” because it closes the active app and navigates to the home screen of the interface. The home button is denoted not by a house, as on many other similar devices, but a rounded square, reminiscent of the shape of icons on the home screen.

A multifunction sleep/wake button is located on the top of the device. It serves as the unit's power button, and also controls phone calls. When a call is received, pressing the sleep/wake button once silences the ringtone, and when pressed twice transfers the call to voicemail. Situated on the left spine are the volume adjustment controls.

The iPhone 4 has two separate circular buttons to increase and decrease the volume; all earlier models house two switches under a single plastic panel, known as a rocker switch. Directly above the volume controls is a silence button that mutes all sound when engaged. All buttons except Home were made of plastic on the original iPhone and metal on all later models. The touch screen furnishes the remainder of the user interface.

The display responds to three sensors. A proximity sensor deactivates the display and touch screen when the device is brought near the face during a call. This is done to save battery power and to prevent inadvertent inputs from the user's face and ears. An ambient light sensor adjusts the display brightness which in turn saves battery power. A 3-axis accelerometer senses the orientation of the phone and changes the screen accordingly, allowing the user to easily switch between portrait and landscape mode. Photo browsing, web browsing, and music playing support both upright and left or right widescreen orientations. Unlike the iPAD, the iPhone does not rotate the screen when turned upside-down, with the Home button above the screen. The 3.0 update added landscape support for still other applications, such as email, and introduced shaking the unit as a form of input. The accelerometer can also be used to control third party apps, notably games. The iPhone 4 also includes a gyroscopic sensor, enhancing its perception of how it is moved.

A software update in January 2008 allowed the first generation iPhone to use cell tower and Wi-Fi network locations trilateration, despite lacking GPS hardware. The iPhone 3G, 3GS and 4 employ A-GPS, and the iPhone 3GS and 4 also have a digital compass.

### Audio and Output

One of two speakers (left) and the microphone (right) surround the dock connector on the base of the original iPhone. If a headset is plugged in, sound is played through it instead.

The bottom of the iPhone sports a speaker (left) and a microphone (right) flanking the dock connector. One loudspeaker is located above the screen as an earpiece, and another is located on the left side of the bottom of the unit, opposite a microphone on the bottom-right. The iPhone 4 includes an additional microphone at the top of the unit for noise cancellation, and switches the placement of the microphone and speaker on the base on the unit—the speaker is on the left. Volume controls are located on the left side of all iPhone models and as a slider in the iPod application.

The 3.5 mm TRRS connector for the headphones is located on the top left corner of the device. The headphone socket on the original iPhone is recessed into the casing, making it incompatible with most headsets without the use of an adapter. Other generations eliminates the issue with a flush-mounted headphone socket. Cars equipped with an auxiliary jack allow for hands free use of the iPhone while driving as a substitute for Bluetooth.

While the iPhone is compatible with normal headphones, Apple provides a headset with additional functionality. A multipurpose button near the microphone can be used to play or pause music, skip tracks, and answer or end phone calls without touching the iPhone. A small number of third-party headsets specifically designed for the iPhone also include the microphone and control button. The current headsets also provide volume controls, which are only compatible with more recent models. These features are achieved by a fourth ring in the audio jack that carries this extra information.

The built-in Bluetooth 2.x+EDR support wireless earpieces and headphones, which requires the HSP profile. Stereo audio was added in the 3.0 update for hardware that supports A2DP. While non-sanctioned third-party solutions exist, the iPhone does not officially support the OBEX file transfer protocol. The lack of these profiles prevents iPhone users from exchanging multimedia files, such as pictures, music and videos, with other Bluetooth-enabled cell phones.

Composite or component video at up to 576i and stereo audio can be output from the dock connector using an adapter sold by Apple. iPhone 4 also supports 1024×768 VGA output via a dock adapter. The iPhone did not support voice recording until the 3.0 software update.

### Battery

Replacing the battery requires opening the iPhone unit and exposing the internal hardware. The iPhone features an internal rechargeable battery. Like an iPod but unlike most other mobile phones, the battery is not user replaceable. The iPhone can be charged when connected to a computer for syncing across the included USB to dock connector cable, similar to charging an iPod. Alternatively, a USB to AC adapter (or “wall charger,” also included) can be connected to the cable to charge directly from an AC outlet. A number of third party accessories (stereos, car chargers, even solar chargers) are also available.

Apple runs tests on preproduction units to determine battery life. Apple's website says that the battery life “is designed to retain up to 80% of its original capacity after 400 full charge and discharge cycles”, which is comparable to iPod batteries. The original iPhone's battery was stated to be capable of providing up to seven hours of video, six hours of web browsing, eight hours of talk time, 24 hours of music or up to 250 hours on standby. The iPhone 3G's battery is stated to be capable of providing up to seven hours of video, six hours of web browsing on Wi-Fi or five on 3G, ten hours of 2G talk time, or five on 3G, 24 hours of music, or 300 hours of standby. Apple claims that the 3GS can last for up to ten hours of video, nine hours of web browsing on Wi-Fi or five on 3G, twelve hours of 2G talk time, or five on 3G, 30 hours of music, or 300 hours of standby.

### Camera

The iPhone and iPhone 3G feature a built-in Fixed focus 2.0 megapixel camera located on the back for still digital photos. It has no optical zoom, flash or autofocus, and does not support video recording, however jailbreaking allows users to do so. Version 2.0 of iPhone OS introduced the capability to embed location data in the pictures, producing geocoded photographs.

The iPhone 3GS has a 3.2 megapixel camera, manufactured by OmniVision, featuring autofocus, auto white balance, and auto macro (up to 10 cm). It is also capable of capturing 640×480 (VGA resolution) video at 30 frames per second, although compared to higher-end CCD based video cameras it does exhibit the rolling shutter effect. The video can then be cropped on the device itself and directly uploaded to YouTube, MobileMe, or other services

The iPhone 4 is the first generation to have two cameras. The LED flash for the rear-facing camera (top) and the forward-facing camera (bottom) are both unique to that model. The iPhone 4 introduced a 5.0 megapixel camera, also located on the back, which is equipped with a backside illuminated sensor capable of capturing pictures in low-light conditions, as well as an LED flash capable of staying lit for video recording at 720p resolution, considered high-definition. In addition the iPhone 4 has a second camera on the front capable of VGA photos and SD video recording.

### Storage and SIM

An iPhone 3G with the SIM slot open. The SIM ejector tool is still placed in the eject hole. The iPhone was initially released with two options for internal storage size: 4 GB or 8 GB. On Sep. 5, 2007, Apple discontinued the 4 GB models. On Feb. 5, 2008, Apple added a 16 GB model. The iPhone 3G was available in 16 GB and is still available with 8 GB. The iPhone 3GS comes in 16 GB and 32 GB variants. All data is stored on the internal flash drive; the iPhone does not support expanded storage through a memory card slot, or the SIM card.

The SIM card sits in a tray, which is inserted into a slot at the top of the device. The SIM tray can be ejected with a paperclip or the “SIM eject tool” (a simple piece of die-cut sheet metal) included with the iPhone 3G and 3GS. In most countries, the iPhone is usually sold with a SIM lock, which prevents the iPhone from being used on a different mobile network. The iPhone 4 features a new MicroSIM card that is located in a slot on the right side of the device.

### Moisture Sensors

Like many modern electronics devices, the iPhone has moisture sensors to indicate whether water damage has affected a device. The sensors on an iPhone include a small disc which is located in the headphone jack and an area near the dock connector. The sensors are often used by Apple employees to determine whether the device qualifies for a warranty repair or replacement, and if the sensors show that the device has absorbed moisture they may determine that the device is not covered. However, the moisture sensors might be “tripped” through routine use, and if a device is worn while exercising the sweat from an owner may dampen the sensors enough to indicate water damage. On many other mobile phones from different manufacturers, the moisture sensors are located in a protected location, such as beneath the battery behind a battery cover, but the sensors on an iPhone are directly exposed to the environment. This has led to criticism of the placement of the sensors, which may also be affected by steam in a bathroom or other light environmental moisture.

Software: iOS (Apple) and iOS version history

The default Home screen of iOS 4 shows most of the applications provided by Apple. Users can download additional applications from the App store, create Web Clips, rearrange the icons, and create folders.

The iPhone (and iPod Touch) run an operating system known as iOS (formerly iPhone OS). It is a variant of the same Darwin operating system core that is found in Mac OS X. Also included is the “Core Animation” software component from Mac OS X v10.5 Leopard. Together with the PowerVR hardware (and on the iPhone 3GS, OpenGL ES 2.0), it is responsible for the interface's motion graphics. The operating system takes up less than half a GB of the device's total storage (4 to 32 GB). It is capable of supporting bundled and future applications from Apple, as well as from third-party developers. Software applications cannot be copied directly from Mac OS X but must be written and compiled specifically for iOS.

Like the iPod, the iPhone is managed with iTunes. The earliest versions of the OS required version 7.3 or later, which is compatible with Mac OS X version 10.4.10 Tiger or later, and 32-bit Windows XP or Vista. The release of iTunes 7.6 expanded this support to include 64-bit versions of XP and Vista, and a workaround has been discovered for previous 64-bit Windows operating systems. Apple provides free updates to the OS for the iPhone through iTunes, and major updates have historically accompanied new models. Such updates often require a newer version of iTunes—for example, the 3.0 update requires iTunes 8.2—but the iTunes system requirements have stayed the same. Updates include both security patches and new features. For example, iPhone 3G users initially experienced dropped calls until an update was issued.

### Interface

The interface is based around the home screen, a graphical list of available applications. iPhone applications normally run one at a time (not including iOS 4, which includes running applications in the background), although most functionality is still available when making a call or listening to music. The home screen can be accessed at any time by a hardware button below the screen, closing the open application in the process.

By default, the home screen contains the following icons: Messages (SMS and MMS messaging), Calendar, Photos, Camera, YouTube, Stocks, Maps (Google Maps), Weather, Voice Memos, Notes, Clock, Calculator, Settings, iTunes (store), App Store, and (on the iPhone 3GS only) Compass. Docked at the base of the screen, four icons for Phone, Mail, Safari (Internet), and iPod (multimedia) delineate the iPhone's main purposes. On Jan. 15, 2008, Apple released software update 1.1.3, allowing users to create “Web Clips”, home screen icons that resemble apps that open a user-defined page in Safari. After the update, iPhone users can rearrange and place icons on up to nine other adjacent home screens, accessed by a horizontal swipe. Users can also add and delete icons from the dock, which is the same on every home screen. Each home screen holds up to sixteen icons, and the dock holds up to four icons. Users can delete Web Clips and third-party applications at any time, and may select only certain applications for transfer from iTunes. Apple's default programs, however, may not be removed. The 3.0 update adds a system-wide search, known as Spotlight, to the left of the first home screen.

Almost all input is given through the touch screen, which understands complex gestures using multi-touch. The iPhone's interaction techniques enable the user to move the content up or down by a touch-drag motion of the finger. For example, zooming in and out of web pages and photos is done by placing two fingers on the screen and spreading them farther apart or bringing them closer together, a gesture known as “pinching”. Scrolling through a long list or menu is achieved by sliding a finger over the display from bottom to top, or vice versa to go back. In either case, the list moves as if it is pasted on the outer surface of a wheel, slowly decelerating as if affected by friction. In this way, the interface simulates the physics of a real object. Other user-centered interactive effects include horizontally sliding sub-selection, the vertically sliding keyboard and bookmarks menu, and widgets that turn around to allow settings to be configured on the other side. Menu bars are found at the top and bottom of the screen when necessary. Their options vary by program, but always follow a consistent style motif. In menu hierarchies, a “back” button in the top-left corner of the screen displays the name of the parent folder.

### Phone

When making a call, the iPhone presents a number of options. The screen is automatically disabled when held close to the face. The iPhone allows audio conferencing, call holding, call merging, caller ID, and integration with other cellular network features and iPhone functions. For example, if music is playing when a call is received, the music fades out, and fades back in when the call has ended. The proximity sensor shuts off the screen and touch-sensitive circuitry when the iPhone is brought close to the face, both to save battery and prevent unintentional touches. The iPhone does not support video calling or videoconferencing on versions prior to the 4th generation, as there is only one camera on the opposite side of the screen. The iPhone 4 supports video calling using either the front or back camera over Wi-Fi, a feature Apple calls “Facetime”. The first two models only support voice dialing through third party applications.^{[109]} Voice control, available only on the iPhone 3GS, allows users to say a contact's name or number and the iPhone will dial.

The iPhone includes a visual voicemail (in some countries) feature allowing users to view a list of current voicemail messages on-screen without having to call into their voicemail. Unlike most other systems, messages can be listened to and deleted in a non-chronological order by choosing any message from an on-screen list.

A music ringtone feature was introduced in the United States on Sep. 5, 2007. Users can create custom ringtones from songs purchased from the iTunes Store for a small additional fee. The ringtones can be 3 to 30 seconds long from any part of a song, can fade in and out, pause from half a second to five seconds when looped, or loop continuously. All customizing can be done in iTunes, or alternatively with Apple's GarageBand software 4.1.1 or later (available only on Mac OS X) or third-party tools.

### Multimedia

The layout of the music library is similar to that of an iPod or current Symbian S60 phones. The iPhone can sort its media library by songs, artists, albums, videos, playlists, genres, composers, podcasts, audiobooks, and compilations. Options are always presented alphabetically, except in playlists, which retain their order from iTunes. The iPhone uses a large font that allows users plenty of room to touch their selection. Users can rotate their device horizontally to landscape mode to access Cover Flow. Like on iTunes, this feature shows the different album covers in a scroll-through photo library. Scrolling is achieved by swiping a finger across the screen. Alternatively, headset controls can be used to pause, play, skip, and repeat tracks. On the iPhone 3GS, the volume can be changed with the included Apple Earphones, and the Voice Control feature can be used to identify a track, play songs in a playlist or by a specific artist, or create a Genius playlist.

The photo display application supports both portrait and landscape orientations. The iPhone supports gapless playback. Like the fifth generation iPods introduced in 2005, the iPhone can play digital video, allowing users to watch TV shows and movies in widescreen. Double-tapping switches between widescreen and full screen video playback.

The iPhone allows users to purchase and download songs from the iTunes Store directly to their iPhone. The feature originally required a Wi-Fi network, but now can use the cellular data network if one is not available.

The iPhone includes software that allows the user to upload, view, and e-mail photos taken with the camera. The user zooms in and out of photos by sliding two fingers further apart or closer together, much like Safari. The Camera application also lets users view the camera roll, the pictures that have been taken with the iPhone's camera. Those pictures are also available in the Photos application, along with any transferred from iPhoto or Aperture on a Mac, or Photoshop in Windows.

### Internet Connectivity

The iPhone 3G introduced support for third-generation UMTS and HSDPA 3.6, but not HSUPA networks, and only the iPhone 3GS supports HSDPA 7.2. AT&T introduced 3G in July 2004, but as late as 2007 Steve Jobs stated that it was still not widespread enough in the US, and the chipsets not energy efficient enough, to be included in the iPhone. Support for 802.1X, an authentication system commonly used by university and corporate Wi-Fi networks, was added in the 2.0 version update.

By default, the iPhone will ask to join newly discovered Wi-Fi networks and prompt for the password when required. Alternatively, it can join closed Wi-Fi networks manually. The iPhone will automatically choose the strongest network, connecting to Wi-Fi instead of EDGE when it is available. Similarly, the iPhone 3G and 3GS prefer 3G to 2G, and Wi-Fi to either. Wi-Fi, Bluetooth, and 3G (on the iPhone 3G and 3GS) can all be deactivated individually. Airplane mode disables all wireless connections at once, overriding other preferences. The iPhone 3GS has a maximum download rate of 7.2 Mbit/s. Furthermore, files downloaded over cellular networks must be smaller than 20 MB. Larger files, often email attachments or podcasts, must be downloaded over Wi-Fi (which has no file size limits). If Wi-Fi is unavailable, one workaround is to open the files directly in Safari.

Safari is the iPhone's native web browser, and it displays pages similar to its Mac and Windows counterparts. Web pages may be viewed in portrait or landscape mode and supports automatic zooming by pinching together or spreading apart fingertips on the screen, or by double-tapping text or images. The iPhone supports SVG, CSS, HTML Canvas, and Bonjour.

The maps application can access Google Maps in map, satellite, or hybrid form. It can also generate directions between two locations, while providing optional real-time traffic information. During the iPhone's announcement, Jobs demonstrated this feature by searching for nearby Starbucks locations and then placing a prank call to one with a single tap. Support for walking directions, public transit, and street view was added in the version 2.2 software update, but no voice-guided navigation. The iPhone 3GS can orient the map with its digital compass.

Apple also developed a separate application to view YouTube videos on the iPhone, which streams videos after encoding them using the H.264 codec. Simple weather and stock quotes applications also tap in to the Internet. iPhone users can and do access the Internet frequently, and in a variety of places. According to Google, the iPhone generates 50 times more search requests than any other mobile handset. According to Deutsche Telekom CEO Rene Obermann, “The average Internet usage for an iPhone customer is more than 100 megabytes. This is 30 times the use for our average contract-based consumer customers.” Nielsen found that 98% of iPhone users use data services, and 88% use the internet. In China, the iPhone 3G and iPhone 3GS were built and distributed without Wi-Fi.

### Text Input

The virtual keyboard on the original iPhone's touch screen. For text input, the iPhone implements a virtual keyboard on the touch screen. It has automatic spell checking and correction, predictive word capabilities, and a dynamic dictionary that learns new words. The keyboard can predict what word the user is typing and complete it, and correct for the accidental pressing of keys near the presumed desired key. The keys are somewhat larger and spaced farther apart when in landscape mode, which is supported by only a limited number of applications. Touching a section of text for a brief time brings up a magnifying glass, allowing users to place the cursor in the middle of existing text. The virtual keyboard can accommodate 21 languages, including character recognition for Chinese. The 3.0 update brought support for cut, copy, or pasting text, as well as landscape keyboards in more applications.

### E-Mail and Text Messages

The iPhone also features an e-mail program that supports HTML e-mail, which enables the user to embed photos in an e-mail message. PDF, Word, Excel, and PowerPoint attachments to mail messages can be viewed on the phone. Apple's MobileMe platform offers push email, which emulates the functionality of the popular BlackBerry email solution, for an annual subscription. Yahoo! offers a free push-email service for the iPhone. IMAP (although not Push-IMAP) and POP3 mail standards are also supported, including Microsoft Exchange and Kerio Connect. In the first versions of the iPhone firmware, this was accomplished by opening up IMAP on the Exchange server. Apple has also licensed Microsoft ActiveSync and now^{]} supports the platform (including push email) with the release of iPhone 2.0 firmware. The iPhone will sync e-mail account settings over from Apple's own Mail application, Microsoft Outlook, and Microsoft Entourage, or it can be manually configured on the device itself. With the correct settings, the e-mail program can access almost any IMAP or POP3 account.

Text messages are presented chronologically in a mailbox format similar to Mail, which places all text from recipients together with replies. Text messages are displayed in speech bubbles (similar to iChat) under each recipient's name. The iPhone currently has built-in support for e-mail message forwarding, drafts, and direct internal camera-to-e-mail picture sending. Support for multi-recipient SMS was added in the 1.1.3 software update. Support for MMS was added in the 3.0 update, but not for the original iPhone and not in the U.S. until Sep. 25, 2009.

### Third Party Applications

At WWDC 2007 on Jun. 11, 2007 Apple announced that the iPhone would support third-party “web applications” written in Ajax that share the look and feel of the iPhone interface. On Oct. 17, 2007, Steve Jobs, in an open letter posted to Apple's “Hot News” weblog, announced that a software development kit (SDK) would be made available to third-party developers in February 2008. The iPhone SDK was officially announced on Mar. 6, 2008, at the Apple Town Hall facility. It allows developers to develop native applications for the iPhone and iPod Touch, as well as test them in an “iPhone simulator”. However, loading an application onto the devices is only possible after paying an Apple Developer Connection membership fee. Developers are free to set any price for their applications to be distributed through the App Store, of which they will receive a 70% share. Developers can also opt to release the application for free and will not pay any costs to release or distribute the application beyond the membership fee. The SDK was made available immediately, while the launch of applications had to wait until the firmware update which was released on Jul. 11, 2008. The update was free for iPhone users, but not for owners of iPod Touches with the 1.x release of iPhone OS, whose operating system can be updated to the current version of iPhone OS, so that they can run iPhone applications, only after paying a small fee.

Once a developer has submitted an application to the App Store, Apple holds firm control over its distribution. For example, Apple can halt the distribution of applications it deems inappropriate as has happened with a US$1000 program that has as sole purpose to demonstrate the wealth of its user. Apple has been criticized for banning third party applications that enable a functionality that Apple does not want the iPhone to have. In 2008, Apple rejected Podcaster, which allowed iPhone users to download podcasts directly to the iPhone claiming it duplicated the functionality of iTunes. Apple has since released a software update that grants this capability. NetShare, another rejected app, would have enabled users to tether their iPhone to a laptop or desktop, using its cellular network to load data for the computer.

Before the SDK was released, third-parties were permitted to design “Web Apps” that would run through Safari. Unsigned native applications are also available. The ability to install native applications onto the iPhone outside of the App Store will not be supported by Apple. Such native applications could be broken by any software update, but Apple has stated it will not design software updates specifically to break native applications other than those that perform SIM unlocking.

### Accessibility

The iPhone can enlarge text to make it more accessible for vision-impaired users, and can accommodate hearing-impaired users with closed captioning and external TTY devices. The iPhone 3GS also features white on black mode, VoiceOver (a screen reader), and zooming for impaired vision, and mono audio for limited hearing in one ear. Apple regularly publishes Voluntary Product Accessibility Templates which explicitly state compliance with the US regulation “Section 508”

### Restrictions

Unlocked iPhone firmware version 3.0. The serial number and Wi-Fi address have been removed from the image. Apple tightly controls certain aspects of the iPhone. The hacker community has found many workarounds, most of which are condemned by Apple and threaten to void the device's warranty. “Jailbreaking” allows users to install apps not available on the App Store or modify basic functionality. SIM unlocking allows the iPhone to be used on a different carrier's network.

### Activation

The iPhone normally prevents access to its media player and web features unless it has also been activated as a phone with an authorized carrier. On Jul. 3, 2007, Jon Lech Johansen reported on his blog that he had successfully bypassed this requirement and unlocked the iPhone's other features with a combination of custom software and modification of the iTunes binary. He published the software and offsets for others to use.

Unlike the original, the iPhone 3G must be activated in the store in most countries. This makes the iPhone 3G more difficult, but not impossible, to hack. The need for in-store activation, as well as the huge number of first-generation iPhone and iPod Touch users upgrading to iPhone OS 2.0, caused a worldwide overload of Apple's servers on Jul. 11, 2008, the day on which both the iPhone 3G and iPhone OS 2.0 updates as well as MobileMe were released. After the update, devices were required to connect to Apple's servers to authenticate the update, causing many devices to be temporarily unusable. Apple avoided this by releasing the 3.0 software two days before the iPhone 3GS.

Users on the O2 network in the United Kingdom, however, can buy the phone online and activate it via iTunes as with the previous model. Even where not required, vendors usually offer activation for the buyer's convenience. In the U.S., Apple has begun to offer free shipping on both the iPhone 3G and the iPhone 3GS (when available), reversing the in-store activation requirement. Best Buy and Wal-Mart will also sell the iPhone.

### Unlicensed Third Party Software and Jailbreaking

The iPhone's operating system is designed to only run software that has an Apple-approved cryptographic signature. This restriction can be overcome by “jailbreaking” the phone, which involves replacing the iPhone's firmware with a slightly modified version that does not enforce the signature check. Doing so may be a circumvention of Apple's technical protection measures. Apple, in a statement to the United States Copyright Office in response to EFF lobbying for a DMCA exception for this kind of hacking, claimed that jailbreaking the iPhone would be copyright infringement due to the necessary modification of system software. Jailbroken iPhones may be susceptible to computer viruses, but few such incidents have been reported.

### B. Google Android Phone.

### Android

Referring still to FIG. 1, in an embodiment of the present technology, the wireless host device 16 comprises an Android phone. Android is an operating system for mobile devices such as cellular phones, tablet computers and netbooks. Android is developed by Google and is based upon the Linux kernel and GNU software. It was initially developed by Android Inc. (a firm later purchased by Google) and lately broadened to the Open Handset Alliance. According to NPD Group, unit sales for Android OS smartphones ranked first among all smartphone OS handsets sold in the U.S. in the second quarter of 2010, at 33%. BlackBerry OS is second at 28%, and iOS is ranked third with 22%.

Android has a large community of developers writing application programs (“apps”) that extend the functionality of the devices. There are currently over 70,000 apps available for Android with some estimates saying 100,000 have been submitted, which makes it the second most popular mobile development environment. Developers write managed code in the Java language, controlling the device via Google-developed Java libraries. The unveiling of the Android distribution on 5 Nov. 2007 was announced with the founding of the Open Handset Alliance, a consortium of 71 hardware, software, and telecom companies devoted to advancing open standards for mobile devices. Google released most of the Android code under the Apache License, a free software and open source license.

### The Android Operating System

The Android operating system software stack consists of Java applications running on a Java based object oriented application framework on top of Java core libraries running on a Dalvik virtual machine featuring JIT compilation. Libraries written in C include the surface manager, OpenCore media framework, SQLite relational database management system, OpenGL ES 2.0 3D graphics API, WebKit layout engine, SGL graphics engine, SSL, and Bionic libc. The Android operating system consists of 12 million lines of code including 3 million lines of XML, 2.8 million lines of C, 2.1 million lines of Java, and 1.75 million lines of C++.

### Acquisition by Google

In July 2005, Google acquired Android, Inc., a small startup company based in Palo Alto, Calif., USA. Google developed a mobile device platform powered by the Linux kernel which was marketed to handset makers and carriers on the premise of providing a flexible, upgradeable system.

### Open Handset Alliance

Open Handset Alliance is a consortium of several companies which include Texas Instruments, Broadcom Corporation, Google, HTC, Intel, LG, Marvell Technology Group, Motorola, Nvidia, Qualcomm, Samsung Electronics, Sprint Nextel and T-Mobile with the goal to develop open standards for mobile devices. Along with the formation of the Open Handset Alliance, the OHA also unveiled their first product, Android, a mobile device platform built on the Linux kernel version 2.6.

### Licensing

With the exception of brief update periods, Android has been available as open source since 21 Oct. 2008. Google opened the entire source code (including network and telephony stacks) under an Apache License. With the Apache License, vendors can add proprietary extensions without submitting those back to the open source community.

### Hardware Running Android

The first phone to run the Android operating system was the HTC Dream, released on 22 Oct. 2008. The HTC Dream (also marketed as T-Mobile G1 in the US and parts of Europe and Era G1 in Poland) is an Internet-enabled 3G smartphone with an operating system designed by Google and hardware designed by HTC. It was the first phone to the market that uses the Android mobile device platform. The phone is part of an open standards effort of the Open Handset Alliance.

Display: 3.2 in (8.1 cm) TFT-LCD flat glass touch-sensitive HVGA screen with 480×320 pixel resolution. The capacitive touch screen makes it impossible to use a standard stylus. Users can interact to bring up or move content with a finger touch, tapping or touch-drag motion. Although the touch screen hardware is capable of multitouch gestures, official releases of the Android OS (versions 1.0 to 1.6) have this functionality disabled for the phone at the kernel level. Users can patch the supplied version of Android, download a hacked version or update to Android 2.0 or later to make use of the multi-touch screen.

The MSM7201A is an ARM-based, dual-core^{[22]} CPU/GPU from Qualcomm and contains many built-in features, including 3G and a GPU capable of up to 4 million triangles/sec. It has hardware acceleration for Java,^{[23]} but this does not accelerate execution of Android applications, as they are targeted to the Dalvik VM, not the Java VM.

The HTC Dream has a sliding full 5 row QWERTY (QWERTZ/AZERTY) keyboard. It also comes with a set of 6 navigation buttons: (i) phone (green, white/black in Germany, UK & France)—make outbound calls, receive incoming calls, or open the dialer; (ii) home (white/black)—displays home screen with shortcut icons for some applications and a drawer containing all applications on the phone; (iii) trackball—navigate among items on the screen or scroll in text fields; (iv) back (white/black)—return to the previous screen; and (v) phone (red, white/black in Germany, UK & France)—end currently active call or put phone into sleep mode.

Menu (white/black)—display the contextual menu for the current screen. A touch screen keyboard is available as of Android 1.5. Side controls are implemented by a pair of volume buttons is located on the left side of the phone, and a camera button on the right side. In place of a headphone jack, the Dream (like many HTC smartphones) has a mini-USB-compatible ExtUSB jack that carries audio signals alongside the regular USB signals, and can be converted with a dongle (now shipped with the phone) to support any standard 3.5 mm headphone. The standard headset includes a clip-on microphone and call answer/hang-up button. The Dream supports audio files in MP3, AAC, AAC+, WMA, MPEG4, WAV, MIDI, and Ogg formats.

The HTC Dream has a 3.2-megapixel camera with autofocus functionality. The Dream can play H.264, streaming, 3GPP, MPEG4, and 3GP files. There is no light (“flash”) for the camera in low light conditions. Video recording and uploading to YouTube is available as of Android 1.5. Recording resolution 352×288 H.263 3GP Mono sound @ 8 kHz.

The HTC Dream has a microSD card slot and comes with a 1 GB memory card (2 GB in the UK, Germany and Canada). It has been confirmed to work with capacities up to 16 GB, and may work with even larger cards. When the USB cable is connected to a computer, this computer can access the card without removing it from the HTC Dream. The phone can access media files arranged in folders, but the folders have to be created from a third-party file management application or from a computer or a third-party file-manager program on the phone.

The HTC Dream has a user-replaceable, 3.7V, 1150 mAh (4.25Whr) rechargeable lithium ion battery, which is advertised to offer up to 130 hours of standby power.

The HTC Dream provides an accelerometer for detecting movement and determining which direction is ‘Up’. It also has a digital compass, giving it complete orientation data. The Dream includes a GPS receiver for fine-grained positioning, and can use cellular or Wi-Fi networks for coarse-grained positioning.

Three different colors of case are available: black, bronze, white.

For connectivity HTC Dream employs Wi-Fi (802.11b/g) using a Texas Instruments WL1251B chipset; Bluetooth 2.0+EDR via Texas Instruments BRF6300; ExtUSB with an SMSC USB3316 chipset; standalone GPS and A-GPS; Quad band GSM 850/900/1800/1900 MHz and GPRS/EDGE, plus Dual band UMTS Bands I and IV (1700 & 2100 MHz) and HSDPA/HSUPA (in US/Europe) at 7.2/2 Mbit/s using the Qualcomm RTR6285 chipset

### Google Applications

Google has also participated in the Android Market by offering several applications for its services. These applications include Google Voice for the Google Voice service, Sky Map for watching stars, Finance for their finance service, Maps Editor for their MyMaps service, Places Directory for their Local Search, Google Goggles that searches by image, Google Translate, Google Shopper, Listen for podcasts and My Tracks, a jogging application.

### Third Party Applications

With the growing number of Android handsets, there has also been an increased interest by third party developers to port their applications to the Android operating system. Notable applications that have been converted to the Android operating system include Shazam, Doodle Jump, and WeatherBug. The Android operating system has grown significantly, and a lot of the most popular internet sites and services have created native applications. These include MySpace, Facebook, and Twitter. As of 15 Jul. 2010, the Android Marketplace had over 70,000 applications, with over 1 billion downloads.

(C) Tablet Computer: Sakshat; iPAD; Android Based Google Tablet; Microsoft Tablet PC; Microsoft Ultra-Mobile PC (UMPC); Nokia 770 Internet Tablet.

### Sakshat

Referring still to FIG. 1, in an embodiment of the present technology, the wireless host device 16 comprises Sakshat. Sakshat is a tablet computing device designed in India as a low cost device in order to attempt to bridge the digital divide. The original prototype unveiled in 2009 was a failure. However, a new prototype unveiled in 2010 has been met with enthusiasm. The device has been developed as part of the National Mission on Education through Information and Communication Technology that aims to link 25,000 colleges and 400 universities on the subcontinent in an e-learning program via an existing Sakshat portal. It has been announced with a price target of [symbol] 1500 ($35) though no manufacturer has been chosen yet.

### History

While it was once projected as a laptop computer, it is actually a tablet computing device. At the inauguration of the national Mission on Education Programme organized by the Union HRD Ministry in 2009, joint secretary N. K. Sinha had said that the computing device is 10 inches long and 5 inches wide and priced at around $30. However, he refused to comment as to why was it being projected as a laptop when it was not. India's Human Resource Development Minister, Kapil Sibal unveiled a prototype on Jul. 22, 2010. The price of the device exhibited was projected to be around $35 per piece, gradually dropping down to $20 and ultimately to $10 a piece. After the new device was unveiled, OLPC Chairman Nicholas Negroponte offered full access to OLPC technology, cost free to the Indian team.

### Hardware

Rugged casing with a rubberized feel, Wi-Fi enabled, Fixed Ethernet capability, Mini and Full USB, MiniSD Card Slot, Sim Card Slot, Video Out, Headphone Jack, 2 GB of Memory using Memory card, 2 Watts of power consumption with solar charging option.

### Software

Android Operating System, educational software developed at Indian Institute of Technology, Web browsing, video conferencing and word processing software.

### Release

Kapil Sibal has stated that a million devices would be made available to students in 2011. The devices will be manufactured at a cost of $35 a piece, half of which will be paid by the government and half by the institutions that would use it.

iPAD

Referring still to FIG. 1, in an embodiment of the present technology, the wireless host device 16 comprises iPAD. The iPAD is a tablet computer designed and developed by Apple. It is particularly marketed as a platform for audio and visual media such as books, periodicals, movies, music, and games, as well as web content. At about 700 grams (25 ounces), its size and weight are between those of most contemporary smartphones and laptop computers. Apple released the iPAD in April 2010, and sold 3 million of the devices in 80 days

The iPAD runs the same operating system as the earlier iPod Touch and iPhone, albeit a slightly older version. It can run its own applications as well as ones developed for the iPhone. Without modification, it will only run programs approved by Apple and distributed via its online store.

Like iPhone and iPod Touch, the iPAD is controlled by a multitouch display sensitive to up to eleven fingers—a break from most previous tablet computers, which used a pressure-triggered stylus. The iPAD uses Wi-Fi or a 3G mobile data connection to browse the Internet, load and stream media, and install software. The device is managed and synced by iTunes on a personal computer via USB cable.

### Screen and Input

The iPAD's touch screen display is a 25 cm (9.7 in) liquid crystal display (1024×768 pixels) with fingerprint-resistant and scratch-resistant glass. Like the iPhone, the iPAD is designed to be controlled by bare fingers; normal gloves and styli that prevent electrical conductivity may not be used, although there are special gloves and styli designed for this use.

The display responds to two other sensors: an ambient light sensor to adjust screen brightness and a 3-axis accelerometer to sense iPAD orientation and switch between portrait and landscape modes. Unlike the iPhone and iPod touch built-in applications, which work in three orientations (portrait, landscape-left and landscape-right), the iPAD built-in applications support screen rotation in all four orientations (the three aforementioned ones along with upside-down), meaning that the device has no intrinsic “native” orientation; only the position of the home button changes.

The iPAD has a switch to lock out the screen rotation function. There are a total of four physical switches, including a home button below the display that returns the user to the main menu, and three plastic physical switches on the sides: wake/sleep and volume up/down, along with the screen rotation lock. Ars Technica noted the similarity between the iPAD and Star Trek's fictional PADD tablet computer, both in name and functionality.

### Connectivity

The iPAD can use Wi-Fi network trilateration from Skyhook Wireless to provide location information to applications such as Google Maps. The 3G model contains A-GPS to allow its position to be calculated with GPS or relative to nearby cell phone towers; it also has a black plastic accent on the back side to improve 3G radio sensitivity. For wired connectivity, the iPAD has a dock connector; it lacks the Ethernet and USB ports of larger computers.

### Audio and Output

The iPAD has two internal speakers that push mono sound through two small sealed channels to the three audio ports carved into the bottom-right of the unit. A volume switch is on the right side of the unit. A 3.5-mm TRS connector audio-out jack on the top-left corner of the device provides stereo sound for headphones with or without microphones and/or volume controls. The iPAD also contains a microphone that can be used for voice recording. The built-in Bluetooth 2.1+EDR interface allows wireless headphones and keyboards to be used with the iPAD. However, the iOS does not currently support file transfer via Bluetooth. iPAD also features 1024×768 VGA video output for connecting an external display or television.

### Power and Battery

The iPAD uses an internal rechargeable lithium-ion polymer battery. The batteries are made in Taiwan by Simplo Technology, which makes 60% of them, and Dynapack International Technology. The iPAD is designed to be charged with a high current (2 amperes) using the included USB 10 W power adapter. While it can be charged by a standard USB port from a computer, these are limited to 500 milliamperes (half an amp). As a result, if the iPAD is turned on while being charged with a normal USB computer port, it will charge much more slowly, if at all.

Apple claims that the iPAD's battery can provide up to 10 hours of video, 140 hours of audio playback, or one month on standby. Like any battery technology, the iPAD's LiPo battery loses capacity over time, but is not designed to be user-replaceable. In a program similar to the battery-replacement program for the iPod and the original iPhone, Apple will replace an iPAD that does not hold an electrical charge with a refurbished iPAD for a fee of US$99 (plus $6.95 shipping).

### Storage and SIM

The iPAD was released with three options for internal storage size: a 16, 32, or 64 GB flash drive. All data is stored on the flash drive and there is no option to expand storage. Apple sells a camera connection kit with an SD card reader, but it can only be used to transfer photos and videos. The side of the Wi-Fi+3G model has a micro-SIM slot (not mini-SIM). Unlike the iPhone, which is usually sold locked to specific carriers, the 3G iPAD is sold unlocked and can be used with any compatible GSM carrier. Japan is the exception to this, where the iPAD 3G is locked to Softbank. In the U.S., data network access via T Mobile's network is limited to slower EDGE cellular speeds because T-Mobile's 3G Network uses different frequencies.

### Optional Accessories

Apple offers several iPAD accessories, including: (i) iPAD Keyboard Dock with hardware keyboard, 30-pin connector, and audio jack; (ii) iPAD Case which can be used to stand the iPAD in various positions; (iii) iPAD Dock with 30-pin connector and audio jack; (iv) iPAD Dock Connector to VGA Adapter for external monitor or projector; (v) iPAD Camera Connection Kit including a USB Type A connector adapter and an SD card reader, for transferring photos and videos; (vi) iPAD 10W USB Power Adapter with 2 A output (10 W)

### Manufacture

The iPAD is assembled by Foxconn, which also manufactures Apple's iPod, iPhone and Mac Mini, in its largest plant in Shenzhen, China. iSuppli estimated that each iPAD 16 GB Wi-Fi version costs Apple US$259.60 to manufacture, a total that excludes research, development, licensing and patent costs.

Apple does not disclose the makers of iPAD components, but teardown reports and analysis from industry insiders indicate that various parts and their suppliers include: (i) Apple A4 SoC-Samsung; (ii) NAND flash RAM chips-Toshiba; except Samsung for the 64 GB model; (iii) Touch-screen chips-Broadcom; (iv) Touch panels-Wintek; (v) Case-Catcher Technologies; (vi) LCD drivers-Novatek Microelectronics; (vii) Batteries-60% are made in Taiwan by Simplo Technology, 40% by Dynapack International; (viii) Accelerometer-STMicroelectronics.

### Software

Like the iPhone, with which it shares a development environment (iPhone SDK, or software development kit, version 3.2 onwards), the iPAD only runs its own software, software downloaded from Apple's App Store, and software written by developers who have paid for a developer's license on registered devices. The iPAD runs almost all third-party iPhone applications, displaying them at iPhone size or enlarging them to fill the iPod's screen. Developers may also create or modify apps to take advantage of the iPAD's features. Application developers use iPhone SDK for developing applications for iPAD. The iPAD has been shipping with a customized iPAD-only version of iPhone OS, dubbed v3.2; it is supposed to get a version of iOS 4 by fall 2010.

### Applications

The iPAD comes with several applications, including Safari, Mail, Photos, Video, YouTube, iPod, iTunes, App Store, iBooks, Maps, Notes, Calendar, Contacts, and Spotlight Search. Several are improved versions of applications developed for the iPhone. The iPAD syncs with iTunes on a Mac or Windows PC. Apple ported its iWork suite from the Mac to the iPAD, and sells pared down versions of Pages, Numbers, and Keynote apps in the App Store. Although the iPAD is not designed to replace a mobile phone, a user can use a wired headset or the built-in speaker and microphone and place phone calls over Wi-Fi or 3G using a VoIP application.

### Digital Rights Management

The iPAD's design imposes strict restrictions in its usage namely DRM intended to lock purchased video content to Apple's platform, the development model requiring a non-disclosure agreement and paid subscription to develop for the iPAD, and the centralized approval process for apps as well as Apple's general control and lockdown of the platform itself.

### Jailbreaking

Like other iOS Devices, the iPAD can be “jailbroken”, allowing code that is not authorized by Apple to run on the device. Once jailbroken, iPAD users are able to download many applications previously unavailable through the App Store via unofficial installers such as Cydia, as well as illegally pirated applications. Apple claims Jailbreaking voids their warranty on the device in the United States.

Reading a Book on the iPAD

The iPAD has an optional iBooks application that can be downloaded from the App Store, which displays books and other ePub-format content downloaded from the iBookstore. For the iPAD launch on Apr. 3, 2010, the iBookstore is available only in the United States. Several major book publishers including Penguin Books, HarperCollins, Simon & Schuster and Macmillan have committed to publishing books for the iPAD.

### Android Based Google Tablet

Referring still to FIG. 1, in an embodiment of the present technology, the wireless host device 16 using Google's Linux-based Android operating system. In 2010, there have been numerous announcements of such tablets. However, much of android's tablet initiative comes from manufacturers as Google primarily focuses its development on smartphones and restricts the App Market from non-phone devices. There is, however, talk of tablet support from Google coming to its web-centric ChromeOS.

### Google Chrome OS

Google Chrome OS is an upcoming Linux-based, open source operating system designed by Google to work exclusively with web applications. Announced on Jul. 7, 2009, Chrome OS is set to have a publicly available stable release during the second half of 2010. Chrome OS will not be available as a download to run and install. Instead, the operating system will only ship on specific hardware from Google's manufacturing partners. The user interface takes a minimalist approach, resembling that of the Chrome web browser. Because the only application on the device will be a browser incorporating a media player, Google Chrome OS is aimed at users who spend most of their time on the Internet.

### Microsoft Tablet PC

Microsoft has been developing support for tablets running Windows under the Tablet PC name. According to a 2001 Microsoft definition of the term, “Tablet PCs” are pen-based, fully functional x86 PCs with handwriting and voice recognition functionality. Tablet PCs use the same hardware as normal laptops but add support for pen input. For specialized support for pen input, Microsoft released Windows XP Tablet PC Edition. Today there is no tablet specific version of Windows but instead support is built in to both Home and Business versions of Windows Vista and Windows 7. Tablets running Windows get the added functionality of using the touch screen for mouse input, hand writing recognition, and gesture support.

### Microsoft Ultra-Mobile PC (UMPC)

Following Tablet PC, Microsoft announced the UMPC initiative in 2006 which brought Windows tablets to a smaller, touch-centric form factor. This was re-launched in 2010 as Slate PC, to promote tablets running Windows 7, ahead of Apple's iPAD launch. Slate PCs are expected to benefit from mobile hardware advances derived from the success of the netbooks.

While many tablet manufacturers are moving the ARM architecture with lighter operating systems, Microsoft has stood firm to Windows. Though Microsoft has Windows CE for ARM support it has kept its target market for the smartphone industry with Windows Mobile and the new Windows CE 6 based Windows Phone 7. Some manufacturers, however, still have shown prototypes of Windows CE-based tablets running a custom shell.

### Nokia 770 Internet Tablet

Nokia entered the tablet space with the N770 running Maemo, a Debian-based Linux distribution custom-made for their Internet Tablet line. The product line continued with the N900 which is the first to add phone capabilities.

The Nokia 770 Internet Tablet is a wireless Internet appliance from Nokia, originally announced at the Linux World Summit in New York City on May 25, 2005. It is designed for wireless Internet browsing and e-mail functions and includes software such as Internet radio, an RSS news reader, e-book reader, and image viewer and media players for selected types of media. The device went on sale in Europe on Nov. 3, 2005, at a suggested retail price of [symbol] 349 to [symbol] 369 (£245 in the United Kingdom). In the United States, the device became available for purchase through Nokia USA's web site on Nov. 14, 2005 for $359.99. On Jan. 8, 2007, Nokia announced the Nokia N800, the successor to the 770. In July 2007, the price for the Nokia 770 fell to under USD 150/EUR 150/GBP 100.

Intel, following the launch of the UMPC, started the Mobile Internet Device initiative, which took the same hardware and combined it with a Linux operating system custom-built for portable tablets. Intel co-developed the lightweight Moblin operating system following the successful launch of the Atom CPU series on netbooks. In 2010, Nokia and Intel combined the Maemo and Moblin projects to form MeeGo.

(D) Portable Media Player: iPod Touch; MP4 Player.
iPod Touch

Referring still to FIG. 1, in an embodiment of the present technology, the wireless host device 16 comprises an iPod-Touch. The iPod Touch (stylized, trademarked, and marketed as iPod touch), is a portable media player, personal digital assistant, and Wi-Fi mobile platform designed and marketed by Apple Inc. The product was launched on Sep. 5, 2007, at an event called The Beat Goes On. The iPod Touch adds the multi-touch graphical user interface to the iPod line. It is the first iPod with wireless access to the iTunes Store, and also has access to Apple's App Store, enabling content to be purchased and downloaded directly on the device. Apple Inc. has sold over 32 million iPod Touch units as of the end of 2009.

The 2nd generation iPod Touch, featuring external volume controls, a built-in speaker, a contoured back, built-in Nike+, Bluetooth support, and the ability to connect a microphone, was unveiled on Sep. 9, 2008, at the “Let's Rock” keynote presentation.

The 3rd generation iPod Touch with iPhone OS 3.1 was announced and subsequently released on Sep. 9, 2009. It is available with 32 GB or 64 GB of flash memory. Apple also continued offering the 2nd generation 8 GB version. The new 3rd generation iPod Touch includes faster hardware (the same microprocessors, graphics engine, and RAM as the iPhone 3GS), a slightly lower battery life, voice control, light sensor, and bundled earphones with a remote and microphone. The 2nd and 3rd generation iPod Touch can now be updated to iOS 4.x for free, but cannot take advantage of features using the iPhone's camera or GPS receiver

### Hardware

The iPod Touch has a slim rectangular shape with rounded edges, with a glass multi-touch display covering most of the top surface and a physical home button off the touch screen. The display functions similarly to the multi-touch trackpad as implemented in Apple's current line of laptop computers. The touch and gesture features of the iPod Touch are based on technology originally developed by FingerWorks. On Feb. 5, 2008, a 32 GB version was added in addition to the 8 and 16 GB versions. On Sep. 9, 2009, a 64 GB version was added and the 16 GB version was removed from the line-up. Improved graphics were also added to the new 64 GB and 32 GB devices.

### Software

The home screen, called SpringBoard, has a list of icons for the available applications. All iPod Touch models include applications such as Music, Videos, and Photos (collectively duplicating the standard functions of the iPod Classic), iTunes (providing access to the iTunes Music Store), Safari, YouTube, Calendar, Contacts, Clock, Calculator, and Settings. Later models added Mail (accessing POP/IMAP/SMTP e-mail), Maps, Stocks, Notes, and Weather, which could also be added to the earlier models with the purchase of a software upgrade. The user can add direct links to Web sites, called “Web Clips”, to the home screen. All iPod Touch models are equipped with Wi-Fi 802.11b/g. On Jul. 11, 2008, the iPhone OS 2.0 Software Update was released for purchase for the iPod Touch. The update allowed 1st generation iPod Touch devices access to the App Store to download third-party applications, in addition to a host of minor bug fixes. On Jun. 17, 2009, the iPhone OS 3.0 Software Update was released for purchase for the iPod Touch. The update allowed the devices to use new apps, and unlocked the Bluetooth functionality of the 2nd generation iPod Touch, enabling A2DP and P2P apps, as well as file transfer to other (non Apple) devices such as Bluetooth-enabled mobile phones or jailbroken iPods using software such as iBlueNova. On Jun. 21, 2010, the new iOS 4.0 software update was released to second and third generation iPod Touch users for free. It includes multitasking, app folders, backgrounds, iAd, and much more. However, second generation iPod touch devices did not receive multitasking, backgrounds, and Bluetooth keyboard support.

Comparisons to the iPhone and Model Comparisons

The iPod Touch and the iPhone, a smartphone by Apple Inc., share the same hardware platform and run the same iOS operating system. The iPod Touch lacks some of the iPhone's features and associated apps, such as access to cellular networks, or a built-in microphone and camera (and speaker on older models). As a result, the iPod Touch is slimmer and lighter than the iPhone. Multimedia, which is available as a single “iPod” app on the iPhone, is split into music and movies on the iPod Touch. Steve Jobs once referred to the iPod Touch as “training wheels for the iPhone”. The 2nd generation iPod Touch has an external volume switch and a built-in speaker like the iPhone. The 2nd generation also comes with the chrome frame seen on the iPhone 3G, making the two almost identical when viewed from the front. However, there are some notable differences, as there is no speaker above the screen, no silent/ringer switch, the back is metal, and the sleep/wake button is on the other side. The 2nd generation also supports audio input when a headphone or earphone with microphone capabilities is plugged into the audio output (headphone) jack. The iPod Touch 2.0 Software Update supports WPA2 Enterprise with 802.1x authentication. The iPhone OS 3.0 update unlocked Bluetooth capability on the 2nd generation iPod Touch, as the included Wi-Fi chip (Broadcom BCM4325) has Bluetooth support. The 2nd generation iPod Touch is said to have a yellower cast/tint to the display, as compared to the iPhone or the original iPod Touch. The applications processor inside the 2nd generation iPod Touch runs slightly faster than the processor inside the iPhone 3G, but slower than the iPhone 3GS. The first generation iPod Touch works with all “Made for iPod” peripherals, but certain changes that Apple made to the 2nd generation iPod Touch prevent some existing peripherals from recharging the updated player. The Google Street View feature added on iPhone firmware version 2.2 is absent from the same version of firmware released on the iPod Touch but is found in the 3.0 update.

### Requirements

As supplied new, the iPod Touch needs a connection to a computer for initial configuration, for syncing media and installing system software updates. Officially, Apple requires iTunes to be installed on either a Mac OS X or Windows operating system based computer for configuring the iPod Touch. On either operating system, the iPod Touch must be connected through a USB port. The 2nd generation (and onward) iPod Touch will neither connect nor charge using older iPod FireWire cables. Starting with the 2nd generation iPod Touch can only be charged from the 5V pin of the dock connector, while most previous iPod models and the original iPod Touch could also be charged from the 12V pin for FireWire power, ^{[25]} resulting in the newer iPod Touch not charging in vehicles equipped with a FireWire-based iPod connection. At the time of the switch, most aftermarket manufacturers of such equipment however are producing new cables and/or adapters, which convert the vehicle's 12 V to 5 V.

Apple states that the following is required for the iPod Touch: (i) a computer running either Mac OS X 10.4.10 or later Microsoft Windows XP with SP2 or later, Microsoft Windows Vista (32 or 64-bit versions) or Windows 7 iTunes 9.2.0.61 for iOS 4.0.x or later, iTunes 8.2 for iPhone OS 3.0.x or later, iTunes 8.0 for iPhone OS 2.1.x, iTunes 7.6 for iPhone OS 2.0.x or earlier; (ii) an available USB 2.0 port.

Third-party applications

Earphones with an external microphone and controller are compatible with the 2nd generation iPod Touch, and are shipped with the 3rd generation iPod Touch (32 GB and 64 GB only). The only official way to obtain third-party applications for the iPod Touch is Apple's App Store, which is a branch of iTunes Store. The App Store application, available in all versions of iOS from 2.0 onwards, allows users to browse and download applications from a single online repository (hosted by Apple) with the iTunes Store. To develop such software, a software development kit (SDK) was officially announced on Mar. 6, 2008, at an Apple Town Hall meeting. The iPhone SDK allows developers to make applications for the iPhone and iPod Touch after paying a fee to join the development team. The developer can then set the price for the applications they develop and will receive 70% of money earned. The developer can also opt to release the application for free and will not pay any additional costs. Shortly after the iPod Touch was released, hackers were able to “jailbreak” the device through a TIFF exploit. The application installed by this exploit enabled the user to download a selection of unofficial third-party programs.

### Jailbreaking

Jailbreaking the iPod Touch was the only way to get third-party programs when running 1.1.x OSes. These third-party programs could use additional functionality not supported by Apple (such as enabling multitasking or applying themes to the home screen. All officially released versions of iOS through 3.1.2, and 4.0 can be jailbroken, but version 3.1 could not at the time it was released. Servicing an iPod Touch after jailbreaking or other modifications made by unofficial means is not covered by Apple's warranty (however, the jailbreaking process is easily undone by performing a restore through iTunes).

MP4 player

Referring still to FIG. 1, in an embodiment of the present technology, the wireless host device 16 comprises an MP4 player. The name MP4 player is a marketing term for portable media players that comply with certain standards and formats. The name itself is a misnomer, since most MP4 players are incompatible with the MPEG-4 Part 14 or the .mp4 container format. Instead, the term symbolizes their status as successors of MP3 players. In this sense, in some markets like Brazil, any new function added to a given media player is followed by an increase in the number, despite there being no corresponding MPEG-5 standard (as of 2010, the current standard, still being developed, is MPEG-4).

### Anyka

Anyka is a chip that used by many MP4 Players. It supports the same formats as Rockchip.

### Rockchip

Fuzhou Rockchip Electronics' video processing Rockchip has been incorporated into many MP4 players, supporting AVI with no B frames in MPEG-4 Part 2 (not Part 14), while MP2 audio compression is used. The clip must be padded out, if necessary, to fit the resolution of the display. Any slight deviation from the supported format results in a Format Not Supported error message.

### Other Chipsets

Some players, like the Onda VX979+, have started to use chipsets from Ingenic, which are capable of supporting Real Networks' video formats. Also, players with SigmaTel-based technology are compatible with SMV (SigmaTel Video).

### MTV

The MTV video format (no relation to the cable network) consists of a 512-byte file header that operates by displaying a series of raw image frames during MP3 playback. During this process, audio frames are passed to the chipset's decoder, while the memory pointer of the display's hardware is adjusted to the next image within the video stream. This method does not require additional hardware for decoding, though it will lead to a higher amount of memory consumption. For that reason, the storage capacity of an MP4 player is effectively less than that of a player that decompresses files on the fly.

### (E) Netbook: Dell Netbook; ASUS Eee PC; Linux-Based CloudBook; Lenovo S10e Netbook; Lenovo Mini 10 Netbook.

### Netbook

Referring still to FIG. 1, in an embodiment of the present technology, the wireless host device 16 comprises a Netbook. Netbooks (sometimes also called mini notebooks or ultraportables) are a branch of subnotebooks, a rapidly evolving category of small, lightweight, and inexpensive laptop computers suited for general computing and accessing Web-based applications; they are often marketed as “companion devices”, i.e., to augment a user's other computer access.

At their inception in late 2007—as smaller notebooks optimized for low weight and low cost—netbooks omitted certain features (e.g., the optical drive), featured smaller screens and keyboards, and offered reduced specification and computing power. Over the course of their evolution, netbooks have ranged in size from below 5″ screen diagonal to 10.1″, although manufacturers have marketed some notebooks with screens up to and over 11.6″ as netbooks. A typical weight is 1 kg (2-3 pounds). Often significantly less expensive than other laptops, by mid-2009, some wireless data carriers began to offer netbooks to users “free of charge”, with an extended service contract purchase. In the short period since their appearance, netbooks have grown in size and features, now converging with new smaller, lighter notebooks. By August 2009, when comparing a Dell netbook to a Dell notebook, CNET called netbooks “nothing more than smaller, cheaper notebooks,” noting, “the specs are so similar that the average shopper would likely be confused as to why one is better than the other,” and “the only conclusion is that there really is no distinction between the devices.” However, in the same month, Walt Mossberg called them a “relatively new category of small, light, minimalist, and cheap laptops.”

### Hardware

An MSI Wind netbook motherboard featuring the Intel Atom processor Netbooks typically have less powerful hardware than larger laptop computers. Some netbooks do not even have a conventional hard drive. Such netbooks use solid-state storage devices instead, as these require less power, are faster, lighter, and generally more shock-resistant, but with much less storage capacity (such as 8, 16, or 32 GB compared to the 80 to 500 GB mechanical hard drives typical of many notebooks/laptop computers).

All netbooks on the market today support Wi-Fi wireless networking and many can be used on mobile telephone networks with data capability (for example, 3G). Mobile data plans are supplied under contract in the same way as mobile telephones. ^{[43]} Some also include Ethernet and/or modem ports, for broadband or dial-up Internet access, respectively

### Processor Architecture

Most netbooks, such as those from Asus, BenQ, Dell, Toshiba, Acer use the Intel Atom notebook processor (typically the N270 1.6 GHz but also available is the N280 at 1.66 GHz, replaced by the N450 series with graphics and memory controller integrated on the chip in early 2010 and running at 1.66 GHz), but the x86-compatible VIA Technologies C7 processor is also powering netbooks from many different manufacturers like HP and Samsung. VIA has also designed the Nano, a new x86-64-compatible architecture targeting lower priced, mobile applications like netbooks. Currently, one netbook uses the Nano; the Samsung NC20. Some very low cost netbooks use a System-on-a-chip Vortex86 processor meant for embedded systems, just to be “Windows compatible”, but with very low performance. AMD plans to launch Netbook processors next year which should be included in the netbook Asus Eee PC 1015T and many others.

### ARM

ARM Holdings designs and licenses microprocessor technology with relatively low power requirements and low cost which would constitute an ideal basis for netbooks. In particular, the recent ARM Cortex-A9 MPCore series of processor cores have been touted by ARM as an alternative platform to x86 for netbooks. These systems, when available, will be branded as smartbooks. Freescale, a manufacturer of ARM chips, has projected that, by 2012, half of all netbooks will run on ARM. In June 2009, Nvidia announced a dozen mobile Internet devices running ARM based Tegra SoC's, some of which will be netbooks.

Smartbooks will deliver features including always on, all-day battery life, 3G connectivity and GPS (all typically found in smartphones) in a laptop-style body with a screen size of 5 to 10 inches and a QWERTY keyboard. These systems do not run traditional x86 versions of Microsoft Windows, rather custom Linux operating systems (such as Google's Android or Chrome OS). Other barriers for the adoption of ARM are slowly being removed, for example Adobe is finally working on an implementation of the full version of Flash player for ARM.

### MIPS

Some netbooks use MIPS architecture-compatible processors. These include the Skytone Alpha 400, based on an Ingenic system on chip, and the Gdium netbooks, which uses the 64-bit Loongson processor capable of 400 million instructions per second. While these systems are relatively inexpensive, the processing power of current MIPS implementations usually compares unfavorably with those of x86-implementations as found in current netbooks. After the ARM version, Adobe is planning to release a version of the Adobe Flash Player (version 10.1) for the MIPS platform.

### Windows

As of January 2009, over 90% (96% claimed by Microsoft as of February 2009) of netbooks in the United States are estimated to ship with Windows XP, which Microsoft was later estimated to sell ranging from US$15 to US$35 per netbook. Microsoft has extended the availability of Windows XP for ultra-low cost personal computers from June 2008 until June 2010. However, the discounted license costs only applies to reduced size and functionality netbooks, which effectively enables the production of low-cost PCs while preserving the higher margins of mainstream desktops and “value” laptops as well as avoiding increased use of Linux installations on netbooks. Microsoft is also testing and has demonstrated a ‘Starter’ edition of Windows 7 for this class of devices, and Windows 7 is likely to replace XP on netbooks, and as of the first quarter of 2009 many netbook models previously announced with Windows XP for the US market were in fact being released with Windows 7 Starter instead, at the same price point previously announced for the Windows XP editions. However, unlike on regular desktops or notebooks that were sold with Vista but included a coupon for 7, users could not get a coupon for 7 Starter if they bought a netbook. Windows CE has also been used in netbook applications, due to its reduced feature design, that keeps with the design philosophy of netbooks. Some netbooks have also been sold with Windows Vista (mostly prior to the release of Windows 7). Many netbooks are by default unable to activate Windows in an enterprise environment using a Microsoft Key Management Service (KMS) as they lack System Locked Preinstallation (SLP) capability in their BIOS. The missing feature artificially segments enterprise customers from the lower end Netbook market; some hardware vendors offer an optional SLP-compliant BIOS to enterprise customers at additional cost.

### Linux

As of November 2009, customized Linux distributions are estimated to ship on 32% of netbooks worldwide, making it the second most popular operating system after Windows. As Linux systems normally install software from an Internet software repository, they do not need an optical drive to install software.

As of August 2010, major netbook manufacturers no longer install or support Linux in the United States. The reason for this change of stance is unclear, although it coincides with the availability of Windows 7 Starter and a strong marketing push for the adoption of this OS in the netbook market. However, companies targeting niche markets, such as System76 and ZaReason, continue to pre-install Linux on the devices they sell.

Netbooks have sparked the development of several Linux variants or completely new distributions, which are optimized for small screen use and the limited processing power of the Atom processors which typically power netbooks. Examples include Ubuntu Netbook Edition, EasyPeasy, and Jolicloud, which are all based on Ubuntu, and Moblin, originally supported by Intel but now supported by the Linux Foundation. Both Jolicloud and Moblin purport to be “social oriented” or social networking operating systems rather than traditional “office work production” operating systems. See the full list of Netbook Distributions. An Intel-sponsored beta version of Moblin version 2.0 became available in the autumn of 2009.

### Android

Google's Android software platform, designed for mobile telephone handsets, has been demonstrated on an ASUS Eee PC and its Linux operating system contains policies for mobile internet devices including the original Asus Eee PC 701. ASUS has allocated engineers to develop an Android-based netbook. Freescale have also announced plans for a low-cost ARM-based netbook design, running Android. In May 2009 a contractor of Dell announced it is porting Adobe Flash Lite to Android for Dell netbooks. Acer announced Android netbooks to be available in Q3/2009.

In July 2009, a new project, Android-x86, was created to provide an open source solution for Android on the x86 platform, especially for netbooks. Since the initial work on Android, Google announced a netbook specific operating system, Chrome OS, and future operating system development may be forced into Android for smartphones and similar handhelds, and Chrome OS for traditional keyboard driven machines like netbooks.

### Chrome OS

Google's upcoming Chrome OS is expected to be loaded on some netbooks; some even speculate that Google will launch a Google-branded netbook running the Chrome OS.

### Mac OS X

Mac OS X has been demonstrated running on various netbooks as a result of the OSx86 project, although this is in violation of the operating system's End User License Agreement. Apple has complained to sites hosting information on how to install OS X onto non-Apple hardware (including Wired and YouTube) that have reacted and removed content in response. One article nicknamed a netbook running OS X a “Hackintosh.”

### Other

Netbooks have been demonstrated running other operating systems including FreeBSD, OpenBSD, and Darwin. The Cloud operating system attempts to capitalize on the minimalist aspect of netbooks. User space is limited to a browser application only, in effect making this operating system a browser. In other words there is no operating system; as far as the user is concerned there is only a browser.

### Usage

A June 2009 NPD study found that 60% of netbook buyers never take their netbooks out of the house. Another NPD study indicated that by September 2009 netbooks accounted for 20% of all portable computer shipments. Special “children's” editions of netbooks have been released under Disney branding; their low cost (less at risk), lack of DVD player (less to break) and smaller keyboards (closer to children's hand sizes) are viewed as significant advantages for that target market. The principal objection to netbooks in this context is the lack of good video performance for streaming online video in current netbooks and a lack of speed with even simple games. Adults browsing for text content are actually less dependent on video content than small children who cannot read.

### Netbooks in Education

Netbooks are a growing trend in education for several reasons. The need to prepare children for 21st century lifestyles, combined with hundreds of new educational tools that can be found online, and a growing emphasis on student centered learning are three of the biggest contributing factors to the rising use of Netbook technology in schools. Netbooks offer several distinct advantages in educational settings. First, their compact size and weight make for an easy fit in student work areas. Similarly, the small size makes Netbooks easier to transport than heavier, larger sized traditional laptops. In addition, prices ranging from $200-$600 dollars mean the affordability of Netbooks can be a relief to school budget makers. Despite the small size and price, Netbooks are fully capable of accomplishing most school-related tasks, including word processing, power point presentations, access to the Internet, multimedia playback, and photo management.

### Uses in the Classroom

Netbooks have the potential to change the way students and teachers interact, and have many practical applications in the classroom setting. One major implication of netbooks in schools is cloud computing. Cloud computing eliminates many of the technology related headaches that we have become accustomed to, including incompatibility between home computers and school computers, “data loss” due to computer crash, and printer failure. Virtually all Netbooks have wireless Internet connections, allowing complete access to free online applications and servers. Online conversations and projects can be completed when students are neither working at the same time, nor place.

### Effects on Student Learning

The benefits of integrating netbooks in the classroom are many, but they are maximized when there is a 1-1 student to computer ratio. The benefits of a 1-1 laptop program are many. Studies have shown evidence that students with laptops do more, and higher quality writing, have access to more information, which improves data analysis skills, and that student centered learning is more easily accomplished. Student-centered learning, a growing trend in education recently, maintains a focus on increasing student motivation, cultivating critical thinking and problem solving, and fostering positive student collaboration. It would seem that Netbooks make student centered learning an easier reality to accomplish.

### Dell Netbook

Dell's Inspiron computer product line started as a range of laptop computers targeted at the entry-level, budget, a Mobile Celeron or Mobile Pentium II processor with SDRAM, and had a high starting price of $2,799. As of Jun. 26, 2007 the Inspiron name also refers to a range of Dell's entry-level desktop systems which replaced the Dimension line of desktop PCs. As of 2010, the Inspiron line is mainly a budget line.

### ASUS Eee PC

The Asus Eee PC is a subnotebook/netbook computer line by Asus and a part of the Asus Eee product family. At the time of its introduction in late 2007, it was noted for its combination of a light weight, Linux operating system, solid-state drive and relatively low cost. Newer models have added the option of Windows operating system and traditional hard disk drives. The first Eee PC was a milestone in the personal computer business, launching the netbook category of small, low cost laptops. According to Asus, the name Eee derives from “the three Es,” an abbreviation of its advertising slogan for the device: “Easy to learn, Easy to work, Easy to play”.

### Linux-Based CloudBook

The Cloudbook is an x86 subnotebook, or Ultra-Mobile PC developed by Everex using a VIA processor, chipset, and NanoBook reference design. It competes with the ASUS Eee PC, the OLPC XO-1 and the Classmate PC. The device is categorized as a netbook.

### Features

The Everex Cloudbook has a uniquely located built-in pointing device (a stamp-sized touchpad) on the upper right side of the computer instead of at the bottom of the keyboard as is common for notebook computers. The design of the Cloudbook is intended so it can be held in one hand while typing, or in two hands when using the mouse-cursor control, with the left thumb controlling the two “mouse buttons”, and the right thumb the small trackpad, both mouse pad and keys are placed directly under the screen. This design was chosen so the system could even be used when standing and walking around, instead of only when sitting. The CloudBook is sold as an Ultra-Mobile PC (UMPC) because of this feature, even though it does not have a touch-screen. There are plans to release a version with a touch-screen in the future.

### Software

The CloudBook comes with a completely new version, (compared to the version used in the gPC) of the gOS Linux distribution (based on Ubuntu) and application software from Mozilla, Skype, Facebook, faqly, OpenOffice.org and Google. Originally gOS came with the Enlightenment 0.17 as the window manager, but the new CloudBook version V2 “Rocket” will be based on GNOME. Though the pre-installed operating system is gOS, Everex has released Windows XP hardware drivers, making it simpler to install Microsoft's Windows XP. However, Everex warns that any software outside of the original gOS will not be covered by warranty (though the hardware's warranty will be unaffected).

### Cloudbook MAX

The next generation of CloudBook, when available in 2009, was said to have a processor running at 1.6 GHz, a 80 GB hard drive, touchpad and WiMAX. However the company has ceased operations and therefore this version is unlikely to ever be released.

Lenovo S10e Netbook

The IdeaPad S10 is a line of consumer-oriented netbook computer designed by Lenovo. The computers were put on the market in October 2008 and offer a variety of colors. They are available in “pearl” white, black, red, blue, and pink. They feature a 10.2″ TFT Active Matrix 1024×600 display with a 80 or 160 GB hard disk drive and 512 MB or 1 GB DDR2 RAM, both of which are easily upgraded via a user access panel on the bottom of the netbook. The processor is an Intel Atom 1.6 GHz processor. They support 802.11b/g wireless networking and come with two USB ports, an ExpressCard expansion slot, a 4-in-1 media reader, and a VGA output. These computers have been receiving generally good reviews getting on average, 4 out of 5 stars from consumer reviews, and a 9/10 rating from Wired magazine

### Lenovo Mini 10 Netbook.

ThinkPad X100e is an 11.6-inch notebook powered by AMD and ATI graphics. In addition to the X100e, a ThinkPad Mini 11 and ThinkPad Mini 10 are listed as well. These look like the names of ThinkPad branded 10-inch and 11-inch netbooks.

### HP 2133 Mini-Note PC

The HP 2133 Mini-Note PC is a full-function netbook aimed at the business and education markets. It is available with SUSE Linux Enterprise Desktop, Windows Vista or Windows XP. Its retail price starts at US$499 for the Linux version with 4 GB of flash memory. According to DigiTimes, the netbook is manufactured by Inventec. However according to apcmag it is built by Compal Electronics who also make the MSI Wind and the Dell Inspiron Mini 9. The system was replaced in early 2009 by an upgraded model, the HP Mini 2140, which is also aimed at the education and business market.

### (F) Smartbook: Qualcomm Smartbook; Smartbook AG Portable Computer

### Smartbook

Referring still to FIG. 1, in an embodiment of the present technology, the wireless host device 16 comprises a smartbook. A smartbook is a class of mobile device that combines certain features of both a smartphone and netbook. Smartbooks deliver features including always on, all-day battery life, 3G and/or Wi-Fi connectivity and GPS (all typically found in smartphones) in a laptop or tablet-style body with a screen size of 5 to 10 inches and a physical or soft touch screen QWERTY keyboard. Smartbooks are generally powered by ARM processors, which are more energy-efficient than traditional x86 processors that are typically found in desktop and laptop computers. The first smartbooks expected to hit the market will use variants of the Linux operating system, such as Google's Android or Chrome OS. The ARM processor commonly used in smartbooks allows them to achieve longer battery life than many larger devices using x86 processors. Smartbooks tend to be designed more for entertainment purposes than for productivity purposes and typically are targeted to work with online applications and may be also sold subsidized through mobile network operators, like mobile phones, along with a wireless data plan. Nokia's N900 is on the cusp of smartphone and smartbook.

### Qualcomm Smartbook

The smartbook concept was first published by Qualcomm in early 2009, with devices expected to hit the market later that year. Difficulties in adapting key software (in particular, Adobe's proprietary Flash Player) to the ARM architecture delayed releases until the first quarter of 2010, during which about 20 devices are expected to be released. Snapdragon is the name of the architecture of a family of chipsets with an ARM-based CPU. The architecture was developed by Qualcomm (which calls Snapdragon a “platform”) for use in smartphones and mobile computing devices.

The Snapdragon platform is designed for real time ubiquitous computing with low power consumption for day-long battery life. The first chipsets in the Snapdragon family were the QSD8650 and the QSD8250, available since the fourth quarter of 2008, both integrating a 1 GHz applications processor, a cellular modem and GPS. 45 nanometer LP process variants, QSD8x50A clocked at up to 1.3 GHz with 30% less power consumption, were sampled by the end of 2009.

The Snapdragon application processor core, dubbed Scorpion, is Qualcomm's own design. It has many features similar to those of the ARM Cortex-A8 core, but theoretically has much higher performance for multimedia-related SIMD operations. All Snapdragon processors contain the circuitry to decode High-Definition (HD) video at 720p resolution. The GPU is an AMD Z430. The latest QSD8672 chip (sampled in the second half of 2009) uses 45 nm technology and includes two CPU cores running at up to 1.5 GHz. QSD8672 product targets advanced mobile computing devices and includes integrated HSPA+, GPS, Bluetooth, full high definition video recording and playback, Wi-Fi and mobile TV technologies (MediaFLO, DVB-H and ISDB-T).^{[4]} Mobile devices using the QSD8672 are expected to become available in the second half of 2010.

Devices using Snapdragon

The first mobile internet device to use a 1 GHz Snapdragon was Toshiba's TG01 smartphone. This was shortly followed by Acer's neoTouch. In 2009 HTC Corporation used the QSD8250 1 GHz chipset in the HTC HD2. Qualcomm claims the architecture will be able to drive screens of up to 12 in (30 cm), at resolutions up to 1440×900 pixels (WSXGA).

### ASUS Eee PC

In June 2009 Qualcomm presented an ASUS Eee PC using the Snapdragon processor and running Google's Linux distribution Android. At the same event, ASUS also showed a Snapdragon-based device, then withdrew it abruptly. Acer's Android-based Liquid A1 Smartphone, launched in December 2009, also uses a Snapdragon processor running at 768 MHz

LG eXpo

The LG eXpo was the first US phone to utilize the Snapdragon processor, shortly followed by the Google Nexus One. The Nexus One, released 5 January 2010, and manufactured by HTC, features Android OS 2.1 and is powered by a Snapdragon running at 1 GHz (Qualcomm QSD8250).

### Lenovo Skylight

The Lenovo Skylight is a 10 in (25 cm) mobile HD device which uses a 1 GHz Snapdragon processor. The HTC Desire and the Sony Ericsson XPERIA X10 are also using this processor, as is the HTC Incredible, a newly introduced smartphone for Verizon Wireless.

### HTC Droid Incredible

The HTC Droid Incredible uses the Snapdragon QSD8650 1 GHz processor The newly-released HTC EVO 4G also uses the Snapdragon QSD8650 1 GHz processor as well, and was available on the Sprint network as of Jun. 4, 2010. The Dell Streak uses the QSD 8250 processor.

### Smartbook AG Portable Computer

A German company Smartbook AG sells laptops under the brand Smartbook. The company holds a trademark for the word Smartbook in a number of countries (not including some big markets like United States, China, Japan or India) and is at the moment acting to preempt others from using the term smartbook to describe their products.

Products had been reportedly sold since 2001. Examples of the company's Smartbook product line include following models: i-1100Z (2006), i-1500C (2006), i-2500V (2006), i-3900Y (2006), i-7500N (2007), Predator (2008), Heaven XTC (2008), ZENiD (2008), Hornet (2008), ZENiD GC CRYSTAL & Smartbook Heaven Puro (2009) and [SK] Sarah Kern Crystal (2010).

(G) e-Reader: Nintendo e-Reader; E-Book; Amazon Kindle; Sony Reader; Barnes & Noble Nook.
e-Reader

Referring still to FIG. 1, in an embodiment of the present technology, the wireless host device 16 comprises an e-Reader. The e-Reader is a device made by Nintendo for its Game Boy Advance portable video game system. It was first released in Japan in December 2001, with a US release following in September 2002. It has a LED scanner that reads “e-Reader cards”, paper cards with specially encoded data printed on them. Depending on the card and associated game, the e-cards are typically used in a key-like function to unlock secret items, levels, or play mini-games when swiped through the reader. See below for a comprehensive list of cards and their functions.

The e-Reader is neither a console nor an accessory, but an add-on device, like the Famicom Disk System or the Sega CD. The e-Reader is one of only three official Nintendo add-ons to be released in North America. The other two are the Super Nintendo Entertainment System's Super Game Boy and the Nintendo GameCube's Game Boy Player. It is also one of the very few Nintendo add-on successes, compared to the 64DD and Famicom Disk System.

Nintendo e-Reader

Two versions were released in Japan: the original e-Reader (without a link cable port), which could read cards to unlock game content, etc.; and later the e-Reader+(simply “e-Reader” in Australia and North America), which came with a link cable port to connect with Nintendo GameCube games such as Animal Crossing and with other Game Boy Advance systems for games such as Pokémon Ruby and Sapphire.

The e-Reader was only considered successful in Japan. It was announced for Europe but very few were made, as it was almost immediately canceled, and it was discontinued in North America in early 2004, due to a lack of popularity. In Japan, however, it sold much better and was produced up to the discontinuation of the Game Boy hardware line.

### Dot Code

Data is encoded on the cards using “dot code”, a specialized barcode technology licensed from Olympus Corporation. e-Reader Cards may have one or two sets of dot code on them, either a wide strip on the left side of the card, a wide strip on both the left and right sides of the card, a narrow strip on the bottom of the card or a short strip on the bottom of the card with a long strip on the left side of the card. Smaller games may require scanning only one card (two sets of dot code), while the greater NES games can require as many as five cards (ten sets of dot code) in order to start the application.

The shorter sets of dot code were only used with the Pokémon Trading Card Game. Cards released in regular sets published by both Nintendo and Wizards of the Coast had dot code on the bottom side of the card. When scanned, the e-Reader displayed a Pokédex data entry for the Pokémon shown on the card. Many of the cards published by Wizards of the Coast included a left side dot code that would allow users to play mini-games, animations, and use secret attacks in the Trading Card Game or play with various songs and graphics.

### E-Book

An e-book (short for electronic book and also known as a digital book, e-book, and eBook) is an e-text that forms the digital media equivalent of a conventional printed book, sometimes restricted with a digital rights management system. An e-book, as defined by the Oxford Dictionary of English, is “an electronic version of a printed book which can be read on a personal computer or hand-held device designed specifically for this purpose.” E-books are usually read on dedicated hardware devices known as e-Readers or e-book devices. Personal computers and some cell phones can also be used to read e-books.

### Amazon Kindle

Amazon Kindle is a software and hardware platform developed by Amazon.com (subsidiary Lab126) for the rendering and displaying of e-books and other digital media. Four hardware devices, known as “Kindle”, “Kindle 2”, “Kindle 3”, and “Kindle DX” support this platform. Kindle software applications exist for Microsoft Windows, iOS, BlackBerry, Mac OS X and Android. Amazon's first hardware device, the Kindle First Generation, was released only in the United States on Nov. 19, 2007. The latest hardware device, the 3rd generation Kindle with 3G support for use in 100 countries and territories, was announced on Jul. 28, 2010.

The Kindle hardware devices use an E Ink brand electronic paper display that features 16 shades of gray. Early Kindles wirelessly downloaded content over Amazon's Whispernet using the Sprint EVDO network in the USA. Newer Kindle 2 devices use AT&T's network and its roaming partners for international wireless access. The Kindle hardware device is used without a computer connection, and Amazon Whispernet is accessible without any monthly fee or wireless subscription. All Kindle models (except the Kindle Wi-Fi) provide free access to the Internet in the U.S. over cellular networks, although fees can be incurred for the delivery of periodicals and other content when roaming internationally beyond the customer's home country. The Kindle does not preserve the print edition page numbers used for creating and verifying sources, references and citations

Through a technology called “Whispersync”, customers can connect reading progress, bookmarks and other information across Kindle hardware devices and other mobile devices.

Amazon announced the Kindle DX on May 6, 2009. This device has a larger screen than its predecessors and supports simple PDF files. It also is the thinnest Kindle to date and offers an accelerometer, which enables the user to seamlessly rotate pages between landscape and portrait orientations when the Kindle DX is turned on its side. It is marketed as more suitable for displaying newspaper and textbook content.

Amazon released the Kindle for PC application free of charge, allowing users to read Kindle books on a Windows PC. Amazon later released a version for the Macintosh. Versions for mobile devices running on operating systems from Research in Motion, Apple and Google are also available free of charge. It is known for its stop motion commercials featuring Annie Little, sporting the song “Fly Me Away” and “Stole My Heart”. The slogan is “Books in 60 seconds”.

With the announcement of the Kindle 3 in July 2010, Amazon also launched an Amazon.co.uk version of the Kindle store. As yet it's unclear whether users who move out the UK will be able to transfer existing purchases to Amazon.com^{[14]}. However, existing UK users are offered the option of migrating to the UK Kindle store, with no loss to their existing purchases.

### Sony Reader

The Sony Reader is a line of e-book readers manufactured by Sony. It uses an electronic paper display developed by E Ink Corporation that has 166 dpi (200 dpi in 5 inch version PRS-300) resolution, eight levels of grayscale (16 in the PRS-900 model), is viewable in direct sunlight, requires no power to maintain a static image, and is usable in portrait or landscape orientation. The reader uses an iTunes Store-like interface to purchase books from Sony Connect eBook store (currently US and Canada only). It also can display Adobe PDFs, ePub format, RSS newsfeeds, JPEGs, and Sony's proprietary BBeB (“BroadBand eBook”) format. The Reader can play MP3 and unencrypted AAC audio files. The digital rights management rules of the Reader allow any purchased e-book to be read on up to six devices, at least one of which must be a personal computer running Windows or Mac OS X. Although the owner cannot share purchased eBooks on others' devices and accounts, the ability to register five Readers to a single account and share books accordingly is a possible workaround. The Sony Reader competes with other e-paper devices: the Amazon Kindle, iRex iLiad, the Jinke Hanlin e-Reader, CyBook by Bookeen, BeBook by Endless Ideas BV, the Kobo e-Reader and the Barnes & Noble nook.

### Barnes & Noble Nook

The Barnes & Noble Nook (styled “nook”) is an electronic-book reader developed by Barnes & Noble, based on the Android platform. The device was announced in the United States on 20 Oct. 2009, and was released 30 Nov. 2009 for US$259. The nook includes Wi-Fi and AT&T 3G wireless connectivity, a six-inch E Ink display, and a separate, smaller color touch screen that serves as the primary input-device. On Jun. 21, 2010 Barnes & Noble reduced the Nook's price to US$199 and announced the launch of a new Wi-Fi-only model for US$149.

Numerous embodiments of the wireless host device 16 that support the present technology are disclosed above. Referring still to FIG. 1, we are now focusing on an embodiment of the present technology, wherein the wireless host device 16 is implemented by using an iPAD Host device.

In an exemplary embodiment of the present technology, FIG. 2 shows the block diagram 30 of the IPAD host device 32.

The IPAD host device 32 has limited hardware connectivity for input and output signals, but does have a variety of RF, and audio peripherals.

As shown in FIG. 2, the IPAD host device 32 has an LCD (liquid crystal display) 34 that can be configured to send the host data to the gaming accessory.

More specifically, in an embodiment of the present technology, the host-data is generated by utilizing an element of the LCD screen 34 that can include a change of color, a variation of intensity of color, a sequence of flashing patterns, or a change of the background theme of the LCD screen 34.

The Star Catcher game was fully disclosed in the co-pending patent application “MULTIFUNCTIONAL GAMING PLATFORM”, Ser. No. 12/871,887, filed on Aug. 30, 1010, and assigned to the assignee to the present patent application. The patent application “MULTIFUNCTIONAL GAMING PLATFORM”, Ser. No. 12/871,887, is incorporated herein in its entirety.

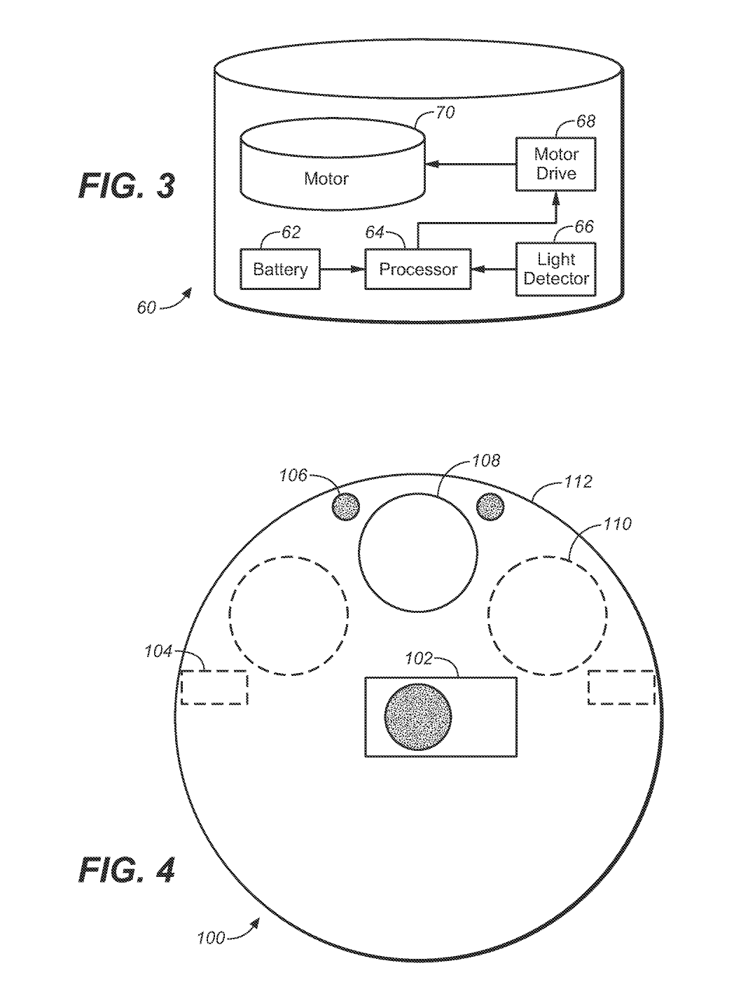

In an exemplary embodiment of the present technology, when the players play the Star Catcher game, the gaming accessory hardware 12 (of FIG. 1) is shown in more details as the Duo block diagram 60 of FIG. 3.

In an embodiment of the present technology, as shown in FIG. 3, the servo motor 70 is activated by the host data that can include a sequence of flashing patters emitted by the Host LCD display (34 of FIG. 2). The Duo gaming accessory hardware 12 actually sits on top of the Host LCD screen 14 (as shown in FIG. 1) and is positioned in a way that allows a portion of the Host LCD display screen 34 to align with the light detector 66.

In an embodiment of the present technology, when the light detector (66 of FIG. 3) and its associated processor (64 of FIG. 3) detect the “proper” light sequence, the servo motor (70 of FIG. 3) is activated, wherein the “proper” light sequence is detected by using a special predetermined coded message that controls the servo motor (shown as the item 204 of FIG. 6). The usage of the coded messages allows preventing an accidental or unauthorized use of the Duo gaming accessory.

In an embodiment of the present technology, the light detector 66 of FIG. 3, can be implemented by using a number of different image-capturing devices including but not limited to: a monochromatic camera; a multispectral camera; a hyper spectral camera; a visible camera; an infrared (IR) camera; an ultraviolet (UV) camera;

A digital camera is a camera that takes video or still photographs, or both, digitally by recording images via an electronic image sensor. Digital cameras can do things film cameras cannot: displaying images on a screen immediately after they are recorded, storing thousands of images on a single small memory device, recording video with sound, and deleting images to free storage space. Some can crop pictures and perform other elementary image editing. Fundamentally they operate in the same manner as film cameras, typically using a lens with a variable diaphragm to focus light onto an image pickup device.

The combination of the diaphragm and a shutter mechanism is used to admit the correct amount of light to the imager, just as with film; the only difference is that the image pickup device is electronic rather than chemical. Digital cameras are incorporated into many devices ranging from PDAs and mobile phones (called camera phones) to vehicles.

The fundamental element of a digital image of an object is the pixel which describes a single point of color or a grayscale.

Each pixel contains a series of numbers which describe its color or intensity. The precision to which a pixel can specify color is called its bit or color depth. The more pixels an image contains, the more detail it has the ability to describe.

Since a pixel is just a logical unit of information, it is useless for describing real-world dimensions unless you also specify their size. The term pixels per inch (PPI) was introduced to relate this theoretical pixel unit to real-world visual resolution.

“Pixels per inch” (PPI) is a very straightforward term. It describes just that: how many pixels an image contains per inch of distance in the horizontal and vertical directions.

A “megapixel” is simply a unit of a million pixels. A digital camera may use a sensor array of megapixels (millions of tiny pixels) in order to produce an image. When the camera's shutter button is pressed and the exposure begins, each of these pixels has a “photo site” which stores photons. Once the exposure finishes, the camera tries to assess how many photons fell into each. The relative quantity of photons in each cavity are then sorted into various intensity levels, whose precision is determined by bit depth (0-255 for an 8-bit image).

In an embodiment of the present technology, the light detector 66 includes a multispectral camera. Multi-spectral imaging is a technology to acquire image data at specific wavelengths across the electromagnetic spectrum. The wavelengths may be separated by filters or by the use of instruments that are sensitive to particular wavelengths, including light from frequencies beyond the visible light range, such as infrared. Multi-spectral imaging can allow extraction of additional information that the human eye fails to capture with its receptors for red, green and blue.

In an embodiment of the present technology, the light detector 66 includes a hyper spectral camera. Hyperspectral imaging collects and processes information from across the electromagnetic spectrum.

Hyperspectral sensors look at objects using a vast portion of the electromagnetic spectrum. Certain objects leave unique ‘fingerprints’ across the electromagnetic spectrum. These ‘fingerprints’ are known as spectral signatures and enable identification of the materials that make up a scanned object. For example, having the spectral signature for oil helps mineralogists find new oil fields. Hyperspectral sensors collect information as a set of ‘images’. Each image represents a range of the electromagnetic spectrum and is also known as a spectral band. These ‘images’ are then combined and form a three dimensional hyperspectral cube for processing and analysis. The acquisition and processing of hyperspectral images is also referred to as imaging spectroscopy.

The distinction between hyperspectral and multispectral is usually defined as the number of spectral bands. Multispectral data contains from tens to hundreds of bands. Hyperspectral data contains hundreds to thousands of bands. However, hyperspectral imaging may be best defined by the manner in which the data is collected. Hyperspectral data is a set of contiguous bands (usually by one sensor). Multispectral is a set of optimally chosen spectral bands that are typically not contiguous and can be collected from multiple sensors. Resonon West located in Bozeman, Mont. manufactures different Digital Imaging Spectrometers. It should be obvious to a person skilled in the art that the current technology is not limited to any spectral band.

The electromagnetic spectrum encompasses radiation from gamma rays, x-rays, ultra violet, a thin region of visible light, infrared, terahertz waves, microwaves, and radio waves. These are all related and differentiated in the length of their wave (wavelength).

In an embodiment of the present technology, the light detector 66 (or, more broadly, an electromagnetic spectrum detector) includes an infrared (IR) camera.

In an embodiment of the present technology, the light detector 66 (or, more broadly, an electromagnetic spectrum detector) includes an ultraviolet (UV) camera.

An image sensor is a device that converts an optical image to an electric signal. It is used mostly in digital cameras and other imaging devices.

In an embodiment of the present technology, the light detector 656 comprises an image sensor selected from the group consisting of: a charge-coupled device (CCD); an active pixel sensor (APS) array; a Complementary Metal Oxide Silicon (CMOS) sensor; a light sensor; a photodiode; a phototransistor; a photoconductive Cell; an IR Detector; a direct image sensor; or any other detector capable of detecting light variances from the 34 display of the iPAD host device 32.

An active pixel sensor (APS) is an image sensor consisting of an integrated circuit containing an array of pixel sensors, each pixel containing a photo detector and an active amplifier. There are many types of active pixel sensors including the CMOS APS used most commonly in cell phone cameras, web cameras and in some DSLRs. Such an image sensor is produced by a CMOS process (and is hence also known as a CMOS sensor), and has emerged as an alternative to charge-coupled device (CCD) imager sensors. Today, most digital still cameras use either a CCD image sensor or a CMOS sensor. Both types of sensor accomplish the same task of capturing light and converting it into electrical signals.

A CCD is an analog device. When light strikes the chip it is held as a small electrical charge in each photo sensor. The charges are converted to voltage one pixel at a time as they are read from the chip. Additional circuitry in the camera converts the voltage into digital information.

A direct image sensor, such as those manufactured by Foveon Inc. of Santa Clara, Calif., separates light into its color components based on the depth of penetration of the photons into the silicon. This obviates the need for individual color filters such as the Bayer pattern filters, and permits co-localization of color information.

In an embodiment of the present technology, as shown in FIG., 4, the servo-motor 102 is used to enable a player to place a bet by dropping game pieces into a trap door by utilizing a hole 108 in the rotating disk 100 that is placed on top of the Star Catcher game.

In an embodiment of the present technology, a player of the Star Catcher game can drop a single token for a single bet by utilizing a hole 108 in the rotating disk (100 of FIG. 4).

In an embodiment of the present technology, a player of the Star Catcher game can drop a plurality of tokens to place a multiple bet by utilizing the same hole 108 in the rotating disk (100 of FIG. 4).

In an embodiment of the present technology, the servo motor 70 of FIG. 3 has to satisfy the following requirements: 3 Volt or less operational voltage (lower voltages are preferred); low enough torque not to cause harm to small fingers (pinch zone); 90 degrees of operation; should be able to accept 3 volt or less control signal; should be able to stay in the same position when the power is removed (control signal); the input should be will be stable during power down.

Referring still to FIG. 4, in an embodiment of the present technology, the rotating disk 100 includes a stop element (a slip clutch) 106 (and 104) placed between the servo motor and the rotating disk to hard stop the rotating disk 100 at 45° after a bet is made.

As shown in FIG. 4, placing a slip clutch 104 between the servo motor 102 and the rotating disk itself protects the servo motor from rough play. The slip clutch also controls the amount of force when objects or body parts accidentally enter a pinch zone (hole) 108.

If the hard end stop slip clutch 104 is used (see previous diagram), the servo motor 102 can realign itself each time it operates. Indeed, the servo motor could be off if the slip clutch 104 is rotated. This also helps to protect the servo motor 102 from the forced travel with or without the slip clutch.

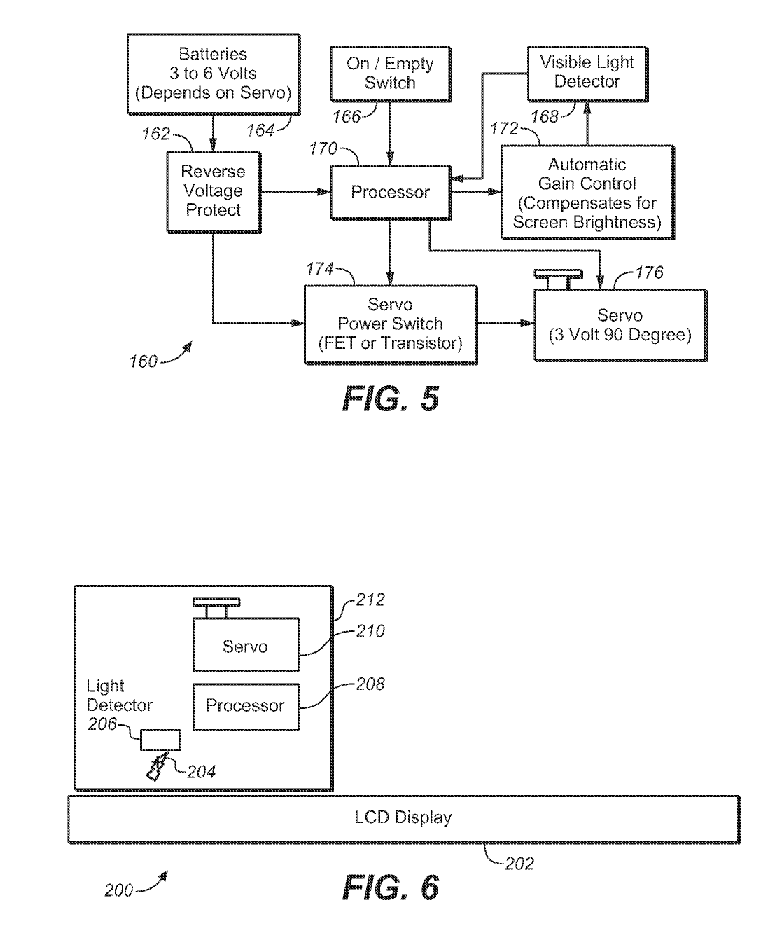

Referring still to FIG. 4, in an embodiment of the present technology, the processor 62 has to satisfy the following I/O requirements (illustrated in more details in FIG. 5): to switch ON/Empty Tokens switch 166 (input with interrupt); to control the servo motor 176 by using the pulse width modulation (PWM) output; to control the servo power switch 174 ON/OFF by using the digital output; to use an automatic gain control block 172 for at least PWM output; and to be controlled by the output signal (analog or digital) from the visible light detector 168.

In an embodiment of the present technology, FIG. 6 is a diagram 200 that illustrates the operation of the Duo gaming accessory 212 (for Star Catcher Product).

In an embodiment of the present technology, more specifically, the LCD Display 202 of the IPAD host device outputs a coded message 204 that is detected and processed by the light detector 206. The recovered control signal is sent from the light detector to the processor 208. The processor controls the operations of the servo motor 210 and the rotating disk 220 in order to enable the operations of the Star Catcher game that was fully disclosed in the copending patent application. The Star Catcher game was fully disclosed in the copending patent application “MULTIFUNCTIONAL GAMING PLATFORM”, Ser. No. 12/871,887, filed on Aug. 30, 1010, and assigned to the assignee to the present patent application.

The above discussion has set forth the operation of various exemplary systems and devices, as well as various embodiments pertaining to exemplary methods of operating such systems and devices. In various embodiments, one or more steps of a method of implementation are carried out by a processor under the control of computer-readable and computer-executable instructions. Thus, in some embodiments, these methods are implemented via a computer.

In an embodiment, the computer-readable and computer-executable instructions may reside on computer useable/readable media.

Therefore, one or more operations of various embodiments may be controlled or implemented using computer-executable instructions, such as program modules, being executed by a computer. Generally, program modules include routines, programs, objects, components, data structures, etc., that perform particular tasks or implement particular abstract data types. In addition, the present technology may also be practiced in distributed computing environments where tasks are performed by remote processing devices that are linked through a communications network. In a distributed computing environment, program modules may be located in both local and remote computer-storage media including memory-storage devices.

Although specific steps of exemplary methods of implementation are disclosed herein, these steps are examples of steps that may be performed in accordance with various exemplary embodiments. That is, embodiments disclosed herein are well suited to performing various other steps or variations of the steps recited. Moreover, the steps disclosed herein may be performed in an order different than presented, and not all of the steps are necessarily performed in a particular embodiment.

Although various electronic and software based systems are discussed herein, these systems are merely examples of environments that might be utilized, and are not intended to suggest any limitation as to the scope of use or functionality of the present technology. Neither should such systems be interpreted as having any dependency or relation to any one or combination of components or functions illustrated in the disclosed examples.

Although the subject matter has been described in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method of interfacing between a host device and a gaming accessory comprising:
(A) using an interface apparatus to receive at least one set of host-data generated by said host device;
and
(B) using said gaming accessory to process said at least one set of host-data and to recover at least one host-control signal by.

2. The method of claim 1 further comprising:
(C) activating said gaming accessory by using said at least one recovered host-control signal.

3. The method of claim 1, wherein said step (A) further comprises:
(A1) selecting said host-device from the group consisting of:
a wired electronic device; and a wireless electronic device.

4. The method of claim 3, wherein said step (A1) further comprises:
(A1, 1) selecting said wireless electronic device from the group consisting of:
a smartphone: a tablet computer; a portable media player; a wearable computer; a netbook; a smartbook; an e-Reader, and a device featuring a display.

5. The method of claim 4, wherein said step (A1, 1) further comprises:
(A1, 1, 1) selecting said smartphone from the group consisting of:
an iPhone; an iPhone 3G; an iPhone 3GS; iPhone 4; and a Google Android phone.

6. The method of claim 4, wherein said step (A1, 1) further comprises:
(A1, 1, 2) selecting said tablet computer from the group consisting of:
A Sakshat; an iPad; an iPad-2; an Android based Google tablet; a Microsoft Tablet PC; a Microsoft Ultra-Mobile PC (UMPC); and a Nokia 770 Internet Tablet;

7. The method of claim 4, wherein said step (A1, 1) further comprises:
(A1, 1, 3) selecting said portable media player from the group consisting of:
an iPod Touch; and an MP4 player.

8. The method of claim 4, wherein said step (A1, 1) further comprises:
(A1, 1, 4) selecting said netbook from the group consisting of:
a Dell netbook; an ASUS Eee PC; a Linux-based CloudBook; a Lenovo S10e netbook; and a Lenovo Mini 10 netbook.

9. The method of claim 4, wherein said step (A1, 1) further comprises:
(A1, 1, 5) selecting said smartbook from the group consisting of:
a Qualcomm smartbook; and a Smartbook AG portable computer.

10. The method of claim 4, wherein said step (A1, 1) further comprises:
(A1, 1, 6) selecting said e-Reader from the group consisting of:
A Nintendo e-Reader; an E-book; an Amazon Kindle; a Sony reader; and a Barnes & Noble nook.

11. The method of claim 1, wherein said step (A) further comprises:
(A2) generating said at least one set of host-data by using an element of a display of said host device.

12. The method of claim 11, wherein said step (A) further comprises:
(A2, 1) selecting said element of said display of said host device from the group consisting of:
a change of color of said display of said host-device; a variation of intensity of color of said display of said host-device; a sequence of flashing patterns generated by said display of said host-device; and a change of a background theme of said display of said host-device.

13. The method of claim 1, wherein said step (A) further comprises:
(A3) receiving said at least one set of host-data by using an image-capturing device.

14. The method of claim 13, wherein said step (A3) further comprises:
(A3, 1) selecting said image-capturing device from the group consisting of:
an image-capturing device capable of detecting light variances from said display of said host device; a multispectral camera; a hyper spectral camera; a visible camera; an infrared (IR) camera; an ultraviolet (UV) camera; and a monochromatic camera.

15. The method of claim 13, wherein said step (A3) further comprises:
(A3, 2) selecting an image sensor from the group consisting of:
a charge-coupled device (CCD); an active pixel sensor (APS) array; a Complementary Metal Oxide Silicon (CMOS) sensor; a light sensor; a photodiode; a phototransistor; a photoconductive Cell; an IR Detector; and a detector capable of detecting light variances from said display of said host device.

16. The method of claim 1, wherein said step (B) further comprises:
(B1) processing said at least one set of host-data to recover said at least one host-control signal by using a processor; wherein said at least one host-control signal is selected from the group consisting of:
a single bet signal; and a multi bet signal.

17. The method of claim 2, wherein said step (C) further comprises:
(C1) activating an element of said gaming accessory by using said at least one recovered host-control signal; wherein said element of said gaming accessory is selected from the group consisting of:
a motor; and an action-generator.

18. The method of claim 17, wherein said step (C1) further comprises:
(C1, 1) selecting said action-generator from the group consisting of:
a light generator; a sound generator; a smell generator; and a mechanical action generator.

19. The method of claim 17, wherein said step (C1) further comprises:
(C1, 2) sending a rotating signal to rotate a betting disk;
(C1, 3) rotating said betting disk on top of said gaming accessory; said betting disk having at least one hole; said betting disk being pivotally attached on top of said gaming accessory;
(C1, 4) hard stopping said betting disk when at least one single token bet is placed by a player by using said at least one hole;
and
(C1, 5) generating said at least one “single bet” light signal; said at least one “single bet” light signal indicative of placing said at least one single token bet.

20. The method of claim 19, wherein said step (C1, 2) further comprises:
(C1, 2, 1) using a servo motor to perform rotation of said betting disk on top of said gaming accessory.

21. The method of claim 19, wherein said step (C1, 4) further comprises:
(C1, 4, 1) using said servo motor to hard stop said betting disk to enable a player to place a single token bet by using a hole in said betting disk.

22. The method of claim 19, wherein said step (C1, 4) further comprises:
(C1, 4, 2) using said servo motor to hard stop said betting disk to enable a player to place a multiple token bet by using a hole in said betting disk.

23. An interface apparatus for multifunctional gaming platform comprising:
a means for receiving at least one set of host-data generated by a host device;
and
a means for processing said at least one set of host-data to recover at least one host-control signal.

24. The interface apparatus of claim 23 further comprising:
a means for activating a gaming accessory by using said at least one recovered host-control signal.

25. The interface apparatus of claim 23, wherein said host-device is selected from the group consisting of:
a wired electronic device; and a wireless electronic device.

26. The interface apparatus of claim 23, wherein said host-device is selected from the group consisting of:
a smartphone; a tablet computer; a portable media player; a wearable computer; a netbook; a smartbook; an e-Reader; and a device featuring a display.

27. The interface apparatus of claim 23, wherein said host-device is selected from the group consisting of:
an iPhone; an iPhone 3G; an iPhone 3GS; iPhone 4; and a Google Android phone.

28. The interface apparatus of claim 23, wherein said host-device is selected from the group consisting of:
a Sakshat; an iPAD; an iPad-2; an Android based Google tablet; a Microsoft Tablet PC; a Microsoft Ultra-Mobile PC (UMPC); and a Nokia 770 Internet Tablet.

29. The interface apparatus of claim 23, wherein said host-device is selected from the group consisting of:
an iPod Touch; and an MP4 player.

30. The interface apparatus of claim 23, wherein said host-device is selected from the group consisting of:
a Dell netbook; an ASUS Eee PC; a Linux-based CloudBook; a Lenovo S10e netbook; and a Lenovo Mini 10 netbook.

31. The interface apparatus of claim 23, wherein said host-device is selected from the group consisting of:
a Qualcomm smartbook; and a Smartbook AG portable computer.

32. The interface apparatus of claim 23, wherein said host-device is selected from the group consisting of:
A Nintendo e-Reader; an E-book; an Amazon Kindle; a Sony reader; and a Barnes & Noble nook.

33. The interface apparatus of claim 23, wherein said at least one set of host-data is selected from the group consisting of:
a change of color of a display of said host-device; a variation of intensity of color of said display of said host-device; a sequence of flashing patterns generated by said display of said host-device; and a change of a background theme of said display of said host-device.

34. The interface apparatus of claim 23, wherein said means for receiving at least one set of host-data generated by a host device further comprises:
an image-capturing device selected from the group consisting of:
an image-capturing device capable of detecting light variances from said display of said host device; a multispectral camera; a hyper spectral camera; a visible camera; an infrared (IR) camera; an ultraviolet (UV) camera; and a monochromatic camera.

35. The interface apparatus of claim 23, wherein said means for receiving at least one set of host-data generated by a host device further comprises:
an image sensor selected from the group consisting of:
a charge-coupled device (CCD); an active pixel sensor (APS) array; a Complementary Metal Oxide Silicon (CMOS) sensor; a light sensor; a photodiode; a phototransistor; a photoconductive Cell; an IR Detector; and a detector capable of detecting light variances from said display of said host device.

36. The interface apparatus of claim 23, wherein said means for processing said at least one set of host-data further comprises:
a processor; wherein said at least one host-control signal is selected from the group consisting of: a single bet signal; and a multi bet signal.

37. The interface apparatus of claim 24, wherein said means for activating said gaming accessory by using said at least one recovered host-control signal further comprises:
an element of said gaming accessory selected from the group consisting of:
a servo-motor; and an action-generator.

38. The interface apparatus of claim 37, wherein said action-generator is selected from the group consisting of:
a light generator; a sound generator; a smell generator; and a mechanical action generator.
